(19) United States
(12) Patent Application Publication
(10) Pub. No.: US 2025/0102221 A1
(43) Pub. Date: Mar. 27, 2025

(54) REFRIGERATOR AND CONTROL METHOD THEREOF

(71) Applicant: Samsung Electronics Co., Ltd., Suwon-si (KR)

(72) Inventors: Hyosuck KANG, Suwon-si (KR); Daesung KIM, Suwon-si (KR); Sanghyeok PARK, Suwon-si (KR); Jongkyoung BOK, Suwon-si (KR); Youngseok CHO, Suwon-si (KR)

(21) Appl. No.: 18/971,879

(22) Filed: Dec. 6, 2024

Related U.S. Application Data
(63) Continuation of application No. PCT/KR2023/010415, filed on Jul. 19, 2023.

(30) Foreign Application Priority Data
Sep. 7, 2022 (KR) 10-2022-0113655

(51) Int. Cl. F25D 29/00; G10L 17/02; G10L 17/22; G10L 25/51

(52) U.S. Cl. CPC F25D 29/003; G10L 17/02; G10L 17/22; G10L 25/51; F25D 2600/06

(57) ABSTRACT

A refrigerator is provided. The refrigerator includes memory storing a preset frequency of the refrigerator and one or more computer programs, a communication interface communicating with a terminal device, a driving unit, and one or more processors communicatively coupled to the memory, wherein the one or more computer programs include computer-executable instructions that, when executed by the one or more processors individually or collectively, cause the refrigerator to receive audio information sensed by the terminal device from the terminal device through the communication interface while the refrigerator operates in a first mode, extract refrigerator noise from the audio information based on the preset frequency, acquire location information of the terminal device based on the refrigerator noise when the refrigerator noise is greater than or equal to a threshold value, and control the driving unit to operate in a second mode different from the first mode when the terminal device is identified as being within a critical distance from the refrigerator based on the location information.

### CROSS-REFERENCE TO RELATED APPLICATION(S)

This application is a continuation application, claiming priority under 35 U.S.C. § 365(c), of an International application No. PCT/KR2023/010415, filed on Jul. 19, 2023, which is based on and claims the benefit of a Korean patent application number 10-2022-0113655, filed on Sep. 7, 2022, in the Korean Intellectual Property Office, the disclosure of which is incorporated by reference herein in its entirety.

### BACKGROUND

### 1. Field

The disclosure relates to a refrigerator and a control method thereof. More particularly, the disclosure relates to a refrigerator that operates in a low-noise mode, taking into account noise generated from a refrigerator and a control method thereof.

### 2. Description of Related Art

The same noise generated from a refrigerator may be perceived as loud or soft depending on the environment in which the user is located. When the user is currently listening to loud music or is in a noisy environment, the noise from the refrigerator may be perceived as relatively soft. However, when the user is sleeping or reading, the noise from the refrigerator may be perceived as relatively loud.

In particular, in situations (e.g., a one-room apartment) where the user has no choice but to live close to the refrigerator, the noise from the refrigerator may have a significant impact on the consumer's life.

A microphone in the refrigerator itself may be used to measure the noise from the refrigerator. When directly measuring the noise from the refrigerator, the noise measured from the refrigerator is used, not the noise directly experienced by the user. Therefore, there is a problem in that the noise directly experienced by the consumer may not be reflected.

In addition, the noise may be measured from a separate location other than the microphone in the refrigerator itself. However, when measuring noise from a different location, it was difficult to accurately determine whether the measured noise was noise directly generated from the refrigerator.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a refrigerator that analyzes a level of noise generated from the refrigerator based on audio information collected from a terminal device communicating with the refrigerator and operates in a low-noise mode based on the analysis result, and a control method thereof.

Additional aspects will be set forth in part in the description which follows and, in part, will be apparent from the description, or may be learned by practice of the presented embodiments.

In accordance with an aspect of the disclosure, a refrigerator is provided. The refrigerator includes memory storing a preset frequency of the refrigerator and one or more computer programs, a communication interface communicating with a terminal device, a driving unit, and one or more processors communicatively coupled to the memory, wherein the one or more computer programs include computer-executable instructions that, when executed by the one or more processors individually or collectively, cause the refrigerator to receive audio information sensed by the terminal device from the terminal device through the communication interface while the refrigerator operates in a first mode, extract refrigerator noise from the audio information based on the preset frequency, acquire location information of the terminal device based on the refrigerator noise when the refrigerator noise is greater than or equal to a threshold value, and control the driving unit to operate in a second mode different from the first mode when the terminal device is identified as being within a critical distance from the refrigerator based on the location information.

The second mode may be a low-noise mode that generates less noise than the noise generated in the first mode.

The memory may store a reference noise corresponding to the preset frequency and an error range corresponding to the preset frequency, and the at least one processor may be configured to extract an audio signal corresponding to the preset frequency from among a plurality of noises included in the audio information and determine the extracted audio signal as the refrigerator noise when a size of the extracted audio signal is within the error range of the reference noise.

The at least one processor may be configured to extract the refrigerator noise from the audio information based on the preset frequency and a preset signal waveform.

The memory may store a distance estimation table indicating a distance corresponding to the refrigerator noise, and the at least one processor may be configured to acquire the distance corresponding to the refrigerator noise based on the distance estimation table as the location information of the terminal device based on the distance estimation table and control the driving unit to operate in the second mode when the distance is identified as being within the critical distance.

The at least one processor may be configured to transmit a control signal requesting the audio information to the terminal device (200) through the communication interface when a preset event occurs, and the preset event may be an event identified as being connectable to the terminal device through the communication interface.

The at least one processor may be configured to identify whether the audio information includes a user conversation when the terminal device is within the critical distance from the refrigerator and control the driving unit to operate the refrigerator in the second mode when the audio information includes the user conversation.

The at least one processor may be configured to transmit a control signal requesting voiceprint information stored in the terminal device to the terminal device through the communication interface when the terminal device is within the critical distance from the refrigerator and identify whether the audio information includes the user conversation based on the voiceprint information when the voiceprint information is received from the terminal device through the communication interface.

The at least one processor may be configured to control the driving unit to operate the refrigerator in the second mode and then acquire a current temperature, and operate the refrigerator by changing the second mode to the first mode when the current temperature is lower than or equal to a critical temperature.

The at least one processor may be configured to acquire environmental noise related to the terminal device based on the audio information, acquire a ratio occupied by the refrigerator noise in the environmental noise, and acquire the location information of the terminal device based on the refrigerator noise when the ratio is greater than or equal to a critical ratio.

In accordance with another aspect of the disclosure, a control method of a refrigerator storing a preset frequency of the refrigerator and communicating with a terminal device is provided. The control method includes receiving audio information sensed by the terminal device from the terminal device while the refrigerator operates in a first mode, extracting refrigerator noise from the audio information based on the preset frequency, acquiring location information of the terminal device based on the refrigerator noise when the refrigerator noise is greater than or equal to a threshold value, and operating the refrigerator in a second mode different from the first mode when the terminal device is identified as being within a critical distance from the refrigerator based on the location information.

The second mode may be a low-noise mode that generates less noise than the noise generated in the first mode.

The refrigerator may store a reference noise corresponding to the preset frequency and an error range corresponding to the preset frequency, and in the extracting of the refrigerator noise, an audio signal corresponding to the preset frequency may be extracted from among a plurality of noises included in the audio information, and when a size of the extracted audio signal is within the error range of the reference noise, the extracted audio signal may be determined as the refrigerator noise.

In the extracting of the refrigerator noise, the refrigerator noise may be extracted from the audio information based on the preset frequency and a preset signal waveform.

The refrigerator may store a distance estimation table indicating a distance corresponding to the refrigerator noise, in the acquiring of the location information, the distance corresponding to the refrigerator noise may be acquired as the location information of the terminal device based on the distance estimation table, and in the operating of the second mode, the refrigerator may operate in the second mode when the distance is identified as being within the critical distance.

The control method may further include transmitting the control signal requesting the audio information to the terminal device 200 when a preset event occurs, and the preset event may be an event that is identified as being connectable to the terminal device.

The operating of the refrigerator in the second mode may include identifying whether the audio information includes the user conversation when the terminal device is within the critical distance from the refrigerator, and operating the refrigerator in the second mode when the audio information includes the user conversation.

The control method may further include transmitting the control signal requesting the voiceprint information stored in the terminal device to the terminal device when the terminal device is within the critical distance from the refrigerator, and identifying whether the audio information includes the user conversation based on the voiceprint information when the voiceprint information is received from the terminal device.

The control method may further include acquiring a current temperature after operating the refrigerator in the second mode, and operating the refrigerator by changing the second mode to the first mode when the current temperature is lower than or equal to the critical temperature.

The control method may further include acquiring the environmental noise related to the terminal device based on the audio information, acquiring the ratio of the refrigerator noise in the environmental noise, and acquiring the location information of the terminal device based on the refrigerator noise when the ratio is greater than or equal to the critical ratio.

In accordance with another aspect of the disclosure, one or more non-transitory computer-readable storage media storing one or more computer programs including computer-executable instructions that, when executed by one or more processors of a refrigerator individually or collectively, cause the refrigerator to perform operations are provided. The operations include receiving audio information sensed by a terminal device from the terminal device while the refrigerator operates in a first mode, extracting refrigerator noise from the audio information based on a preset frequency, acquiring location information of the terminal device based on the refrigerator noise when the refrigerator noise is greater than or equal to a threshold value, and operating the refrigerator in a second mode different from the first mode when the terminal device is identified as being within a critical distance from the refrigerator based on the location information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing the relationship between a refrigerator and a terminal device according to an embodiment of the disclosure;

FIG. 2 is a block diagram illustrating a refrigerator according to an embodiment of the disclosure;

FIG. 3 is a block diagram for describing a specific configuration of the refrigerator of FIG. 2 according to an embodiment of the disclosure;

FIG. 4 is a diagram for describing a user interface (UI) related to a recording progress according to an embodiment of the disclosure;

FIG. 5 is a flowchart for describing an operation of controlling a mode of the refrigerator based on audio information according to an embodiment of the disclosure;

FIG. 6 is a flowchart for describing an operation of acquiring refrigerator noise based on the audio information according to an embodiment of the disclosure;

FIG. 7 is a table for describing frequency characteristics of a plurality of devices according to an embodiment of the disclosure;

FIG. 8 is a table for describing an operation of estimating a distance based on noise according to an embodiment of the disclosure;

FIG. 9 is a flowchart for describing an operation of requesting audio information from a terminal device according to an embodiment of the disclosure;

FIG. 10 is a flowchart for describing an operation of controlling the mode of the refrigerator based on location information received from a terminal device according to an embodiment of the disclosure;

FIG. 11 is a flowchart for describing an operation of controlling the mode of the refrigerator based on wireless fidelity (Wi-Fi) signal information received from the terminal device according to an embodiment of the disclosure;

FIG. 12 is a flowchart for describing an operation of controlling the mode of the refrigerator when a user conversation is identified according to an embodiment of the disclosure;

FIG. 13 is a flowchart for describing an operation of identifying the user conversation based on voiceprint information according to an embodiment of the disclosure;

FIG. 14 is a flowchart for describing an operation of controlling temperature maintenance of the refrigerator according to an embodiment of the disclosure;

FIG. 15 is a flowchart for describing an operation of comparing environmental noise and refrigerator noise according to an embodiment of the disclosure;

FIG. 16 is a flowchart for describing an operation of controlling the mode of the refrigerator in consideration of a ratio of the environmental noise and the refrigerator noise according to an embodiment of the disclosure;

FIG. 17 is a figure for describing the ratio of the environmental noise and the refrigerator noise according to an embodiment of the disclosure;

FIG. 18 is a flowchart for describing an operation of controlling the mode of the refrigerator according to an application running on the terminal device according to an embodiment of the disclosure;

FIG. 19 is a flowchart for describing an operation of analyzing user context information based on a captured image according to an embodiment of the disclosure;

FIG. 20 is a flowchart for describing an operation of providing the UI for changing the mode of the refrigerator according to an embodiment of the disclosure;

FIG. 21 is a diagram for describing the UI for changing the mode of the refrigerator according to an embodiment of the disclosure;

FIG. 22 is a flowchart for describing an embodiment in which a main operation is performed in the terminal device according to an embodiment of the disclosure;

FIG. 23 is a diagram for describing a system including the refrigerator, the terminal device, and a router according to an embodiment of the disclosure;

FIG. 24 is a flowchart for describing an operation of controlling the mode of the refrigerator in a system including the refrigerator, the terminal device, and the router according to an embodiment of the disclosure;

FIG. 25 is a diagram for describing a process of analyzing the impact of refrigerator noise according to an embodiment of the disclosure;

FIG. 26 is a flowchart for describing an operation of controlling the mode and intensity of the refrigerator according to an embodiment of the disclosure;

FIG. 27 is a figure for describing an operation of distinguishing sensing data according to an embodiment of the disclosure;

FIG. 28 is a table for describing the sensing data used to control the refrigerator according to an embodiment of the disclosure;

FIG. 29 is a figure for describing a process of controlling the refrigerator according to the context information according to an embodiment of the disclosure; and

FIG. 30 is a flowchart for describing a method of controlling a refrigerator according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the specification, an expression “have”, “may have”, “include”, “may include”, or the like, indicates existence of a corresponding feature (e.g., a numerical value, a function, an operation, a component such as a part, or the like), and does not exclude existence of an additional feature.

An expression “at least one of A and/or B” is to be understood to represent “A” or “B” or “any one of A and B”.

Expressions “first,” “second,” “1^{st}” or “2^{nd}” or the like, used in the disclosure may indicate various components regardless of a sequence and/or importance of the components, will be used only in order to distinguish one component from the other components, and do not limit the corresponding components.

When it is mentioned that any component (for example, a first component) is (operatively or communicatively) coupled with/to or is connected to another component (for example, a second component), it is to be understood that any component is directly coupled to another component or may be coupled to another component through the other component (for example, a third component).

It should be understood that terms “include” or “formed of” used in the specification specify the presence of features, numerals, steps, operations, components, parts, or combinations thereof mentioned in the specification, but do not preclude the presence or addition of one or more other features, numerals, steps, operations, components, parts, or combinations thereof.

In the disclosure, a “module” or a “˜er/or” may perform at least one function or operation, and be implemented as hardware or software or be implemented as a combination of hardware and software. In addition, a plurality of “modules” or a plurality of “units” may be integrated in at least one module and be implemented by at least one processor (not illustrated) except for a “module” or a “unit” that needs to be implemented by specific hardware.

In this specification, the term user may refer to a person using a refrigerator or a device (e.g., an artificial intelligence electronic device) using a refrigerator.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth© chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

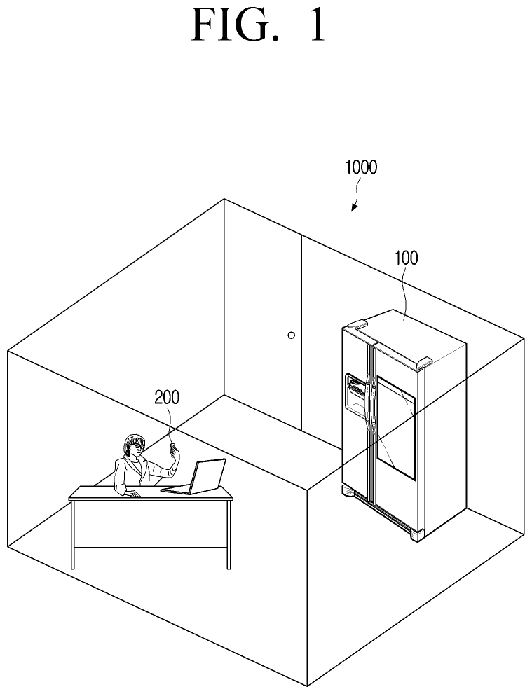

FIG. 1 is a diagram for describing the relationship between a refrigerator 100 and a terminal device 200 according to an embodiment of the disclosure.

A system 1000 of FIG. 1 may include the refrigerator 100 and the terminal device 200. The refrigerator 100 may generate noise depending on functions performed. The closer the refrigerator 100 is to the user, the louder the noise may be felt by the user. Where the user is located can be determined through the location of the terminal device 200. The refrigerator 100 may recognize a level of noise generated from the user's perspective through the terminal device 200. Even if it is noise generated from the refrigerator 100, the importance of the noise may vary depending on the user's location. Therefore, the refrigerator 100 may determine whether a low-noise mode is necessary using the location of the terminal device 200.

One of the factors determining the low-noise mode may be determining whether the user is within a critical distance from the refrigerator 100. Accordingly, the refrigerator 100 may analyze the location of the terminal device 200 to determine that the user is near the refrigerator 100. Then, the refrigerator 100 may execute the low-noise mode for the user.

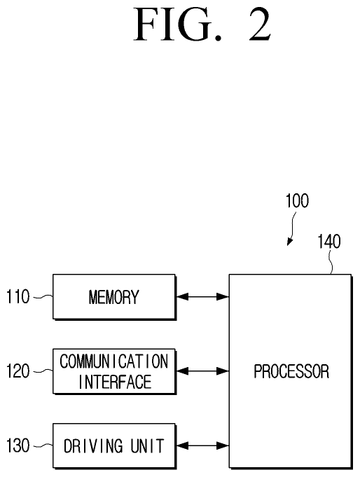

FIG. 2 is a block diagram illustrating the refrigerator 100 according to an embodiment of the disclosure.

Referring to FIG. 2, the refrigerator 100 may include at least one of memory 110, a communication interface 120, a driving unit 130, or at least one processor 140.

The refrigerator 100 may be a device for cooling a refrigerated object with cold air generated through a compressor, a condenser, an expansion device, and an evaporator according to a refrigeration cycle to refrigerate or freeze the refrigerated object. Meanwhile, the disclosure has been described in relation to the refrigerator 100, but according to various embodiments, can be implemented in an electronic device that generates noise other than the refrigerator 100. Therefore, the refrigerator 100 may be described as the electronic device, and the refrigerator noise may be described as electronic device noise.

The memory 110 may store a preset frequency of the refrigerator 100.

The communication interface 120 may communicate with the terminal device 200.

The driving unit 130 may control various hardware configurations included in the refrigerator 100 so that the refrigerator 100 operates in a specific operation mode.

At least one processor 140 may receive audio information sensed by the terminal device 200 from the terminal device 200 through the communication interface 120 while the refrigerator 100 operates in a first mode, extract the refrigerator 100 noise from the audio information based on the a preset frequency, and acquire location information of the terminal device 200 based on the refrigerator 100 noise when the refrigerator 100 noise is greater than a threshold value, and control the driving unit 130 to operate in a second mode different from the first mode when the terminal device 200 is identified as being within a critical distance from the refrigerator 100 based on the location information.

The audio information may refer to audio information collected by the terminal device 200. The audio information may refer to information collected through a microphone of the terminal device 200. The audio information may be described as an audio signal or audio data. At least one processor 140 may analyze audio collected by the terminal device 200, not the refrigerator 100, and determine the refrigerator noise based on the user of the terminal device 200.

The terminal device 200 may refer to a device used by a user. The terminal device 200 may refer to a smartphone or a wearable device. The terminal device 200 may refer to a device including a microphone and a communication interface.

The preset frequency may refer to a frequency of noise generated from the refrigerator. The driving unit 130 included in the refrigerator 100 may include a motor, etc., and may perform rotational motion. Therefore, the refrigerator noise may be generated when the refrigerator 100 performs its function. Here, the refrigerator noise corresponds to constant noise, so it may have a specific frequency. The refrigerator 100 may store the frequency of noise generated from the refrigerator as the preset frequency in the memory 110.

Meanwhile, the second mode may be a low-noise mode that generates less noise than the noise generated in the first mode. The first mode may refer to a general mode or a high-performance mode, and the second mode may refer to a low-noise mode.

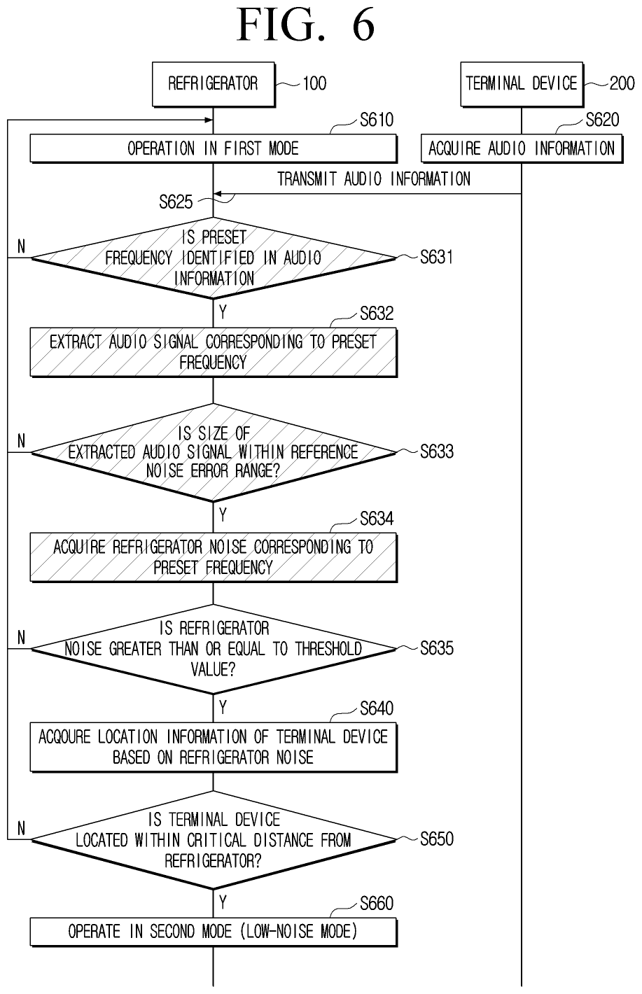

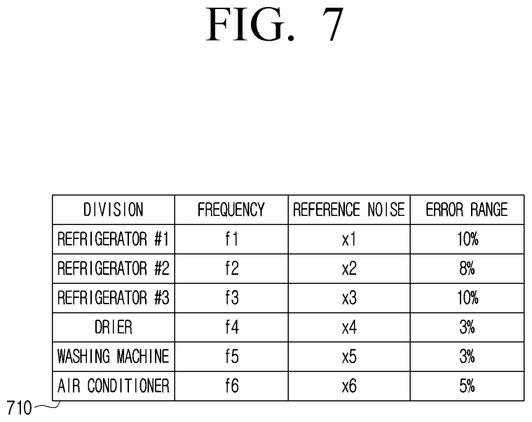

Meanwhile, the memory 110 stores a reference noise corresponding to a preset frequency and an error range corresponding to the preset frequency, and at least one processor 140 may extract an audio signal corresponding to the preset frequency from among a plurality of noises included in the audio information, and determine the extracted audio signal as the refrigerator 100 noise when the size of the extracted audio signal is within the error range of the reference noise. Specific descriptions related thereto will be described later with reference to FIGS. 6 and 7.

The refrigerator 100 noise may be extracted from the audio information based on the preset frequency and a preset signal waveform.

At least one processor 140 may identify the refrigerator noise using the preset frequency. At least one processor 140 may compare the refrigerator noise with the threshold value. Here, the threshold value may mean the lowest noise which a user feels uncomfortable with. Here, the threshold value may be changed according to the user's setting.

When the refrigerator noise is not greater than or equal to the threshold value, at least one processor 140 may determine that the noise currently collected from the terminal device 200 does not cause discomfort to the user. However, when the refrigerator noise is greater than or equal to the threshold value, at least one processor 140 may determine whether the refrigerator 100 needs to operate in the second mode. Specifically, at least one processor 140 may determine whether the user of the terminal device 200 is currently within the critical distance from the refrigerator 100.

At least one processor 140 may acquire the location information of the terminal device 200 based on the refrigerator noise. Here, the location information may include the distance that the terminal device 200 is away from the refrigerator 100.

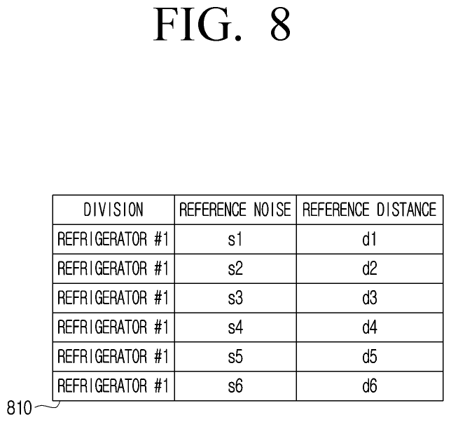

Meanwhile, the memory 110 stores a distance estimation table indicating a distance corresponding to the refrigerator 100 noise, and at least one processor 140 may acquire the distance corresponding to the refrigerator 100 noise as the location information of the terminal device 200 based on the distance estimation table, and control the driving unit 130 to operate the refrigerator 100 in the second mode when it is determined that the distance is within the critical distance. Specific descriptions related thereto will be described in detail with reference to FIG. 8.

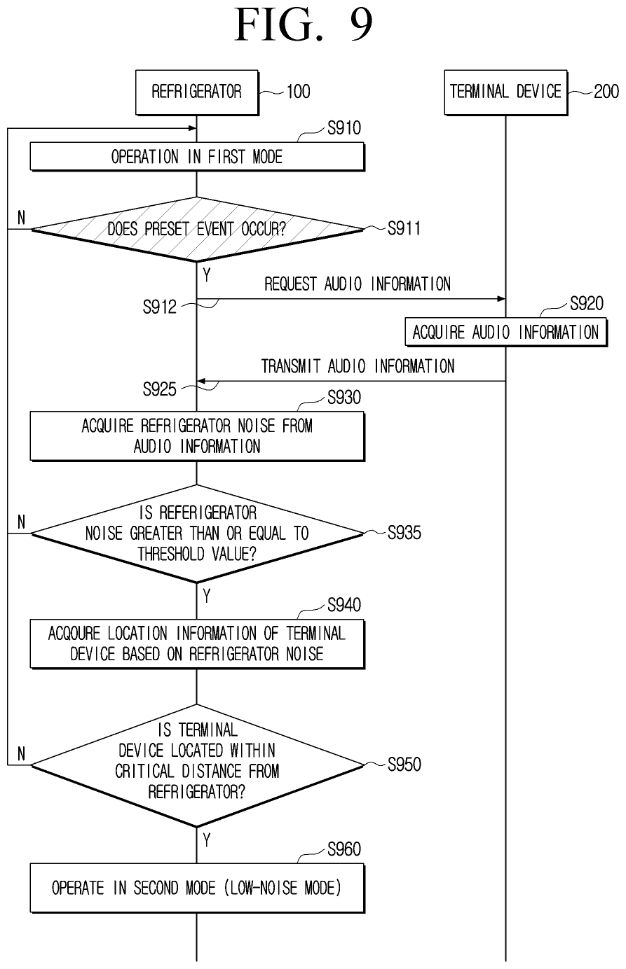

Meanwhile, at least one processor 140 transmits a control signal requesting the audio information to the terminal device 200 through the communication interface 120 when a preset event occurs, and the preset event may be an event identified as being connectable to the terminal device 200 through the communication interface 120. Specific descriptions related thereto will be described in detail with reference to FIG. 9.

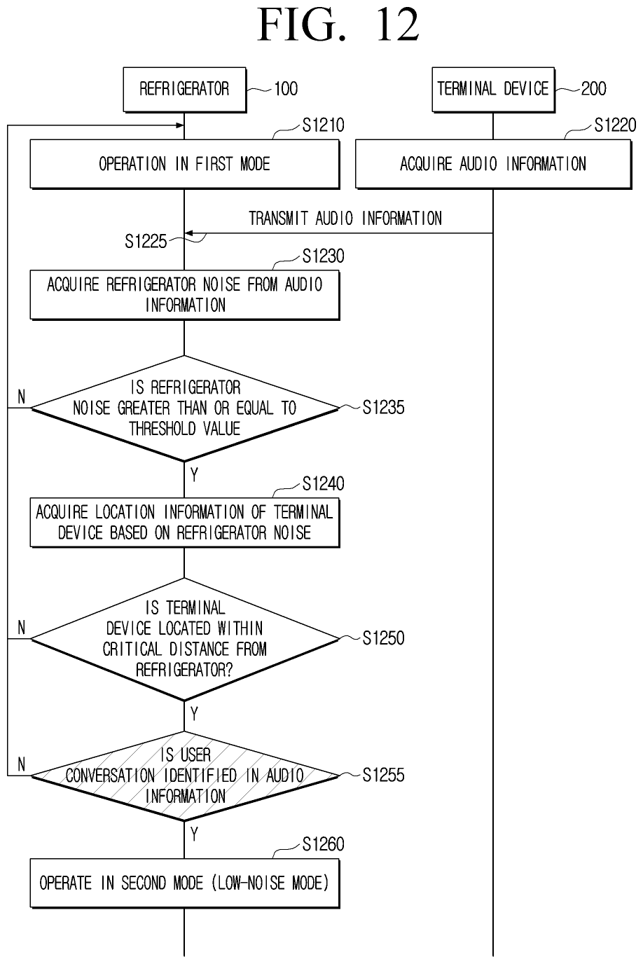

Meanwhile, at least one processor 140 may identify whether the audio information includes the user conversation when the terminal device 200 is within the critical distance from the refrigerator 100, and control the driving unit 130 to operate the refrigerator 100 in the second mode when the audio information includes the user conversation. Specific descriptions related thereto will be described in detail with reference to FIG. 12.

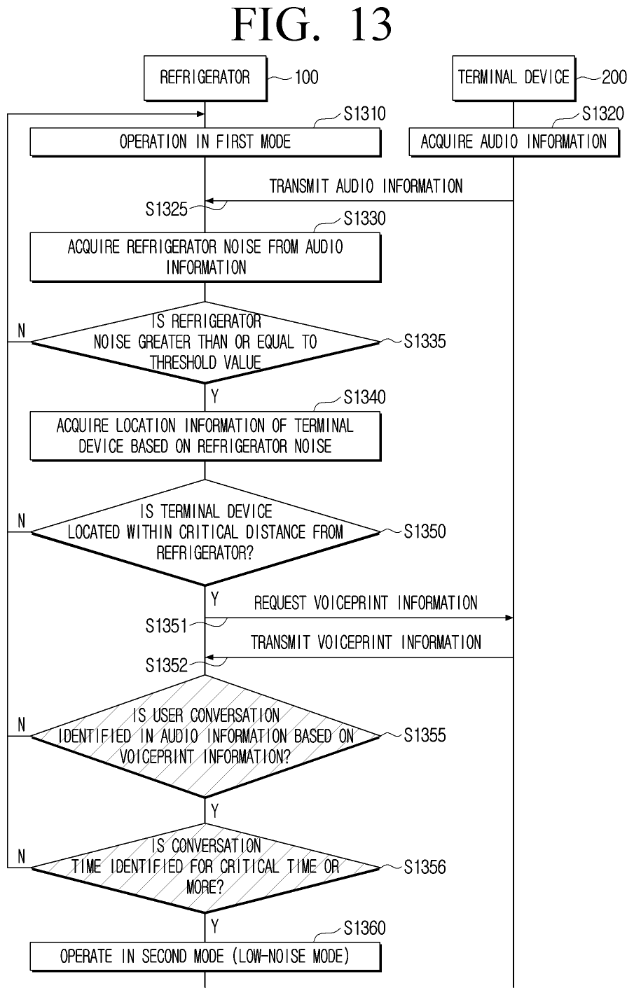

Meanwhile, at least one processor 140 may transmit the control signal requesting the voiceprint information stored in the terminal device 200 to the terminal device 200 through the communication interface 120 when the terminal device 200 is within the critical distance from the refrigerator 100, and identify whether the audio information includes the user conversation based on the voiceprint information when the voiceprint information is received from the terminal device 200 through the communication interface 120. Specific descriptions related thereto will be described in detail with reference to FIG. 13.

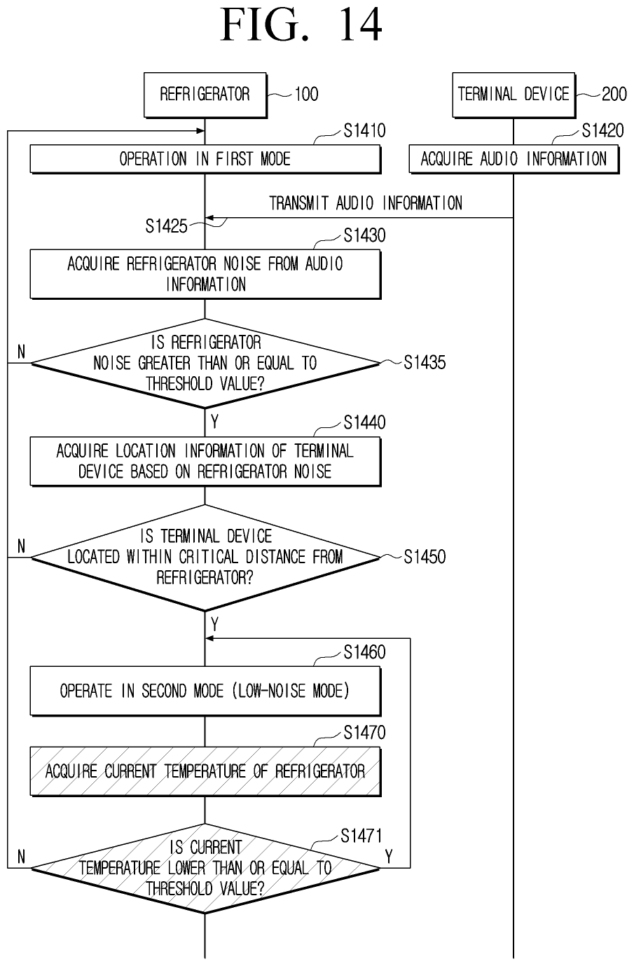

Meanwhile, at least one processor 140 may control the driving unit 130 to operate the refrigerator in the second mode and then acquire the current temperature, and change the second mode to the first mode to operate the refrigerator 100 when the current temperatures is lower than or equal to the critical temperature. Specific descriptions related thereto will be described in detail with reference to FIG. 14.

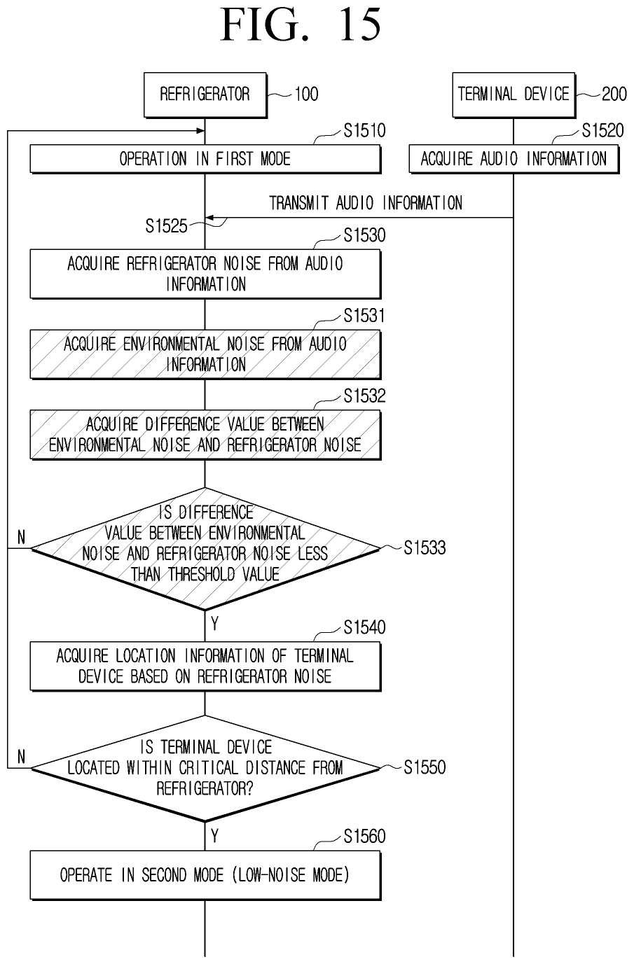

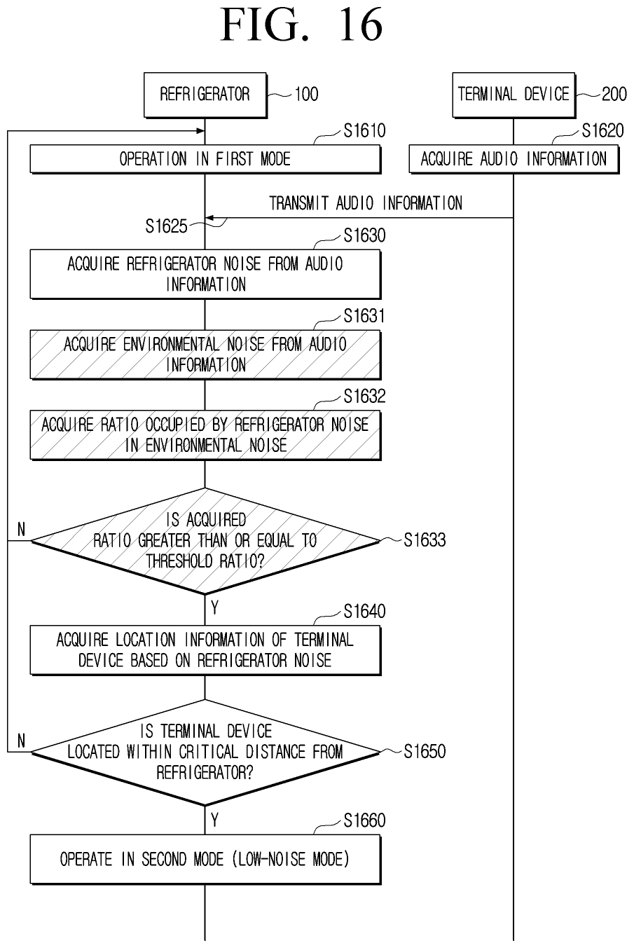

Meanwhile, at least one processor 140 may acquire environmental noise related to the terminal device 200 based on the audio information, acquire a ratio of the refrigerator 100 noise in the environmental noise, and acquire the location information of the terminal device 200 based on the refrigerator 100 noise when the ratio is greater than or equal to a critical ratio. Specific descriptions related thereto will be described in detail with reference to FIGS. 15 and 16.

According to various embodiments of the disclosure, the refrigerator 100 may determine an operation mode by analyzing the audio information collected from the terminal device 200. Accordingly, it is possible to determine whether to execute the low-noise mode by reflecting the noise actually felt by the user in the terminal device 200.

In addition, the refrigerator 100 extracts unique noise generated from the refrigerator 100 using the preset frequency. Therefore, only the noise generated from the refrigerator 100 may be considered separately.

In addition, the refrigerator 100 initiates an operation to separately acquire the environmental noise and refrigerator noise. By considering the ratio of the refrigerator noise in the environmental noise, the refrigerator 100 may relatively consider the refrigerator noise felt by the user of the terminal device 200 with respect to the surrounding environmental noise.

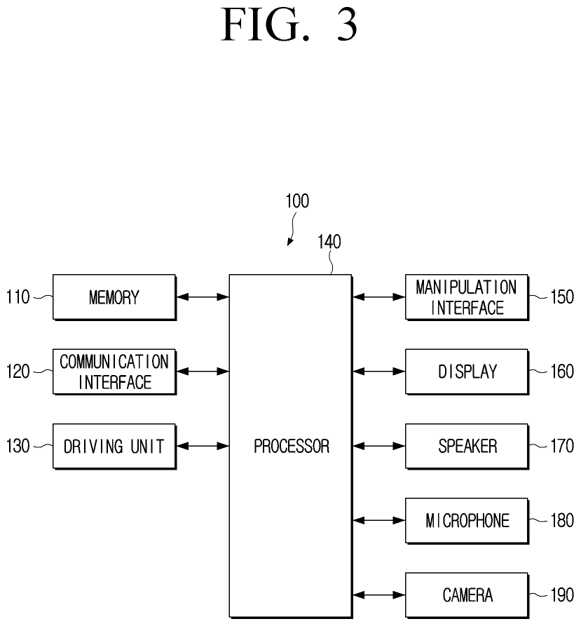

Meanwhile, only simple components constituting the refrigerator 100 have been illustrated and described hereinabove, but various components may be further included in the refrigerator 100 during implementing the refrigerator 100. This will be described below with reference to FIG. 3.

FIG. 3 is a block diagram for describing the specific configuration of the refrigerator 100 of FIG. 2 according to an embodiment of the disclosure.

Referring to FIG. 3, the refrigerator 100 may include at least one of memory 110, a communication interface 120, a driving unit 130, at least one processor 140, a manipulation interface 150, a display 160, a speaker 170, a microphone 180, or a camera 190. Meanwhile, a duplicate description of the same operation as described above will be omitted.

The memory 110 may be implemented as internal memory such as read-only memory (ROM) (e.g., electrically erasable programmable read-only memory (EEPROM)), random access memory (RAM), or the like, included in at least one processor 140 or be implemented as memory separate from at least one processor 140. In this case, the memory 110 may be implemented as memory embedded in the refrigerator 100 or as memory that may be attached or detached to the refrigerator 100 depending on the purpose of data storage. For example, data for driving the refrigerator 100 may be stored in the memory embedded in the refrigerator 100, and data for expanding the functions of the refrigerator 100 may be stored in the memory that may be attached or detached to the refrigerator 100.

Meanwhile, the memory embedded in the refrigerator 100 may be implemented by at least one of volatile memory (for example, dynamic RAM (DRAM), static RAM (SRAM), synchronous dynamic RAM (SDRAM), or the like) or non-volatile memory (for example, one time programmable ROM (OTPROM), programmable ROM (PROM), erasable and programmable ROM (EPROM), electrically erasable and programmable ROM (EEPROM), mask ROM, flash ROM, flash memory (for example, NAND flash, NOR flash, or the like), a hard drive, or a solid state drive (SSD)), and the memory attachable to and detachable from the refrigerator 100 may be implemented in a form such as a memory card (for example, a compact flash (CF), a secure digital (SD), a micro-SD, a mini-SD, an extreme digital (xD), a multi-media card (MMC), or the like), external memory (for example, universal serial bus (USB) memory) connectable to a USB port, or the like.

The communication interface 120 is a component performing communication with various types of external apparatuses according to various types of communication manners. The communication interface 120 may include a wireless communication module or a wired communication module. Here, each communication module may be implemented in the form of at least one hardware chip.

The wireless communication module may be a module that communicates wirelessly with an external device. For example, the wireless communication module may include at least one of a Wi-Fi module, a Bluetooth module, an infrared communication module, or other communication modules.

The Wi-Fi module and the Bluetooth module perform communication in a Wi-Fi method and a Bluetooth method, respectively. When the Wi-Fi module or the Bluetooth module is used, various connection information such as a service set identifier (SSID), a session key, and the like, is first transmitted and received, communication is connected using the connection information, and various information may then be transmitted and received.

The infrared communication module performs communication according to an infrared data association (IrDA) technology of wirelessly transmitting data to a short distance using an infrared ray positioned between a visible ray and a millimeter wave.

Other wireless communication modules may include at least one communication chip performing communication according to various wireless communication standards such as zigbee, 3^{rd} generation (3G), 3^{rd} generation partnership project (3GPP), long term evolution (LTE), LTE advanced (LTE-A), 4^{th} generation (4G), 5^{th} generation (5G), and the like, in addition to the communication manner described above.

The wired communication module may be a module that communicates with an external device in a wired manner. For example, the wired communication module may include at least one of a local area network (LAN) module, an Ethernet module, a pair cable, a coaxial cable, an optical fiber cable, or an ultra wide-band (UWB) module.

The driving unit 130 may include a compressor, a fan motor, etc., that operate under the control of at least one processor 140. The driving unit 130 may control various hardware configurations included in the refrigerator 100 to perform a specific mode or a specific function.

The manipulation interface 150 may be implemented as a device such as a button, a touch pad, a mouse, and a keyboard or may be implemented as a touch screen that may perform both of the abovementioned display function and manipulation input function. Here, the button may be various types of buttons such as a mechanical button, a touch pad, a wheel, and the like, formed in any region such as a front surface portion, a side surface portion, a rear surface portion, and the like, of a body appearance of the refrigerator 100.

The display 160 may be implemented as various types of displays such as a liquid crystal display (LCD), an organic light emitting diode (OLED) display, a plasma display panel (PDP), and the like. A driving circuit, a backlight unit, and the like, that may be implemented in the form such as an amorphous silicon thin film transistor (a-si TFT), a low temperature poly silicon (LTPS) TFT, an organic TFT (OTFT), and the like, may be included in the display 160. Meanwhile, the display 160 may be implemented as a touch screen combined with a touch sensor, a flexible display, a three-dimensional (3D) display, or the like. In addition, the display 160 according to an embodiment of the disclosure may include not only a display panel outputting an image, but also a bezel housing the display panel. In particular, the bezel according to an embodiment of the disclosure may include a touch sensor (not illustrated) for sensing a user interaction.

The speaker 170 is a component outputting various notification sounds, a voice message, or the like, as well as various audio data.

The microphone 180 is a component for receiving a user' voice or other sounds and converting the user's voice or other sounds into audio data. The microphone 180 may receive the user voice in an activated state. For example, the microphone 180 may be formed integrally with the refrigerator 100 in upper, front, side directions, or the like. The microphone 180 may include various components such as a microphone collecting a user voice having an analog form, an amplifying circuit amplifying the collected user voice, an analog-to-digital (A/D) converting circuit sampling the amplified user voice to convert the amplified user voice into a digital signal, a filter circuit removing a noise component from the converted digital signal, and the like.

The camera 190 is configured to generate a captured image by capturing a subject, in which the captured image is a concept including both a moving image and a still image. The camera 190 may acquire an image of at least one external device, and may be implemented as a camera, a lens, an infrared sensor, or the like.

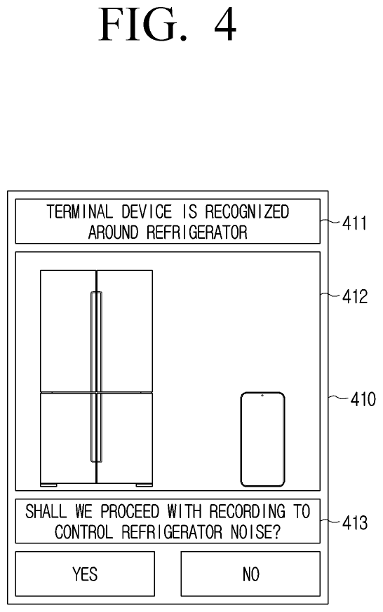

FIG. 4 is a diagram for describing a user interface (UI) related to a recording progress according to an embodiment of the disclosure.

Referring to FIG. 4, the user's permission may be required before performing a recording operation. This is because there is a risk of privacy infringement when recording is performed automatically without the user's permission. The UI 410 related to the recording progress may be provided to the user in at least one of the refrigerator 100 and the terminal device 200. The user may input a user input for consenting to recording in at least one of the refrigerator 100 and the terminal device 200.

The UI 410 related to the recording progress may include at least one of text information 411 for indicating that the refrigerator 100 and the terminal device 200 are located within the critical distance from each other, image information 412 for indicating that the refrigerator 100 and the terminal device 200 are located within the critical distance from each other, or text information 413 for requesting consent related to recording to control the refrigerator noise.

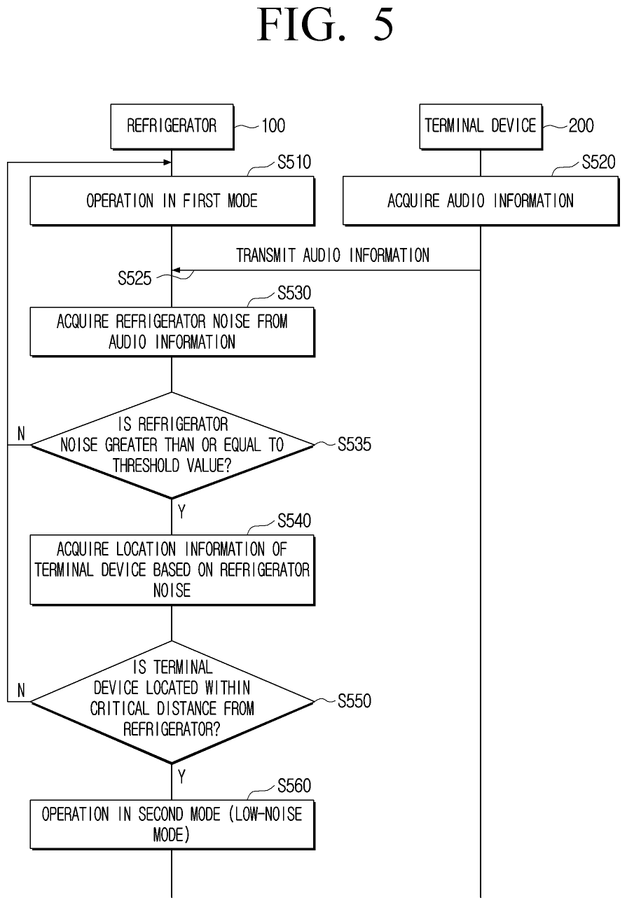

FIG. 5 is a flowchart for describing an operation of controlling the mode of the refrigerator 100 based on the audio information according to an embodiment of the disclosure.

Referring to FIG. 5, the refrigerator 100 may operate in the first mode in operation S510. In addition, the terminal device 200 may acquire the audio information in operation S520. The terminal device 200 may acquire the audio information in real time. The refrigerator 100 may transmit the acquired audio information terminal device 200 to the refrigerator 100 in operation S525.

The refrigerator 100 may receive the audio information from the terminal device 200. The refrigerator 100 may acquire the refrigerator noise from the audio information in operation S530. The audio information may include various environmental noises including the refrigerator noise. The refrigerator 100 may separate (or acquire) only the refrigerator noise from the environmental noise.

The refrigerator 100 may identify whether the refrigerator noise is greater than or equal to the threshold value in operation S535. When the refrigerator noise is not greater than or equal to the threshold value in operation S535-N, the refrigerator 100 may operate in the first mode. That is, the refrigerator 100 may repeat operations S510 to S535. Here, the threshold value may mean a minimum reference value indicating whether the noise generated from the refrigerator causes discomfort to the user.

For all data, when the refrigerator noise is greater than or equal to the threshold value in operation S535-Y, the refrigerator 100 may acquire the location information of the terminal device 200 based on the refrigerator noise in operation S540. The greater the refrigerator noise, the closer the distance between the refrigerator 100 and the terminal device 200 may be. The refrigerator 100 may store table information indicating the location information of the terminal device 200 according to the reference noise in memory 110, etc. Then, the refrigerator 100 may identify the location of the terminal device 200 based on the table information indicating the distance corresponding to the reference noise stored in the memory 110. The table information related to this is described in Table 810 of FIG. 8. The location information of the terminal device 200 may include the distance that the terminal device 200 is away from the refrigerator 100.

The refrigerator 100 may identify whether the terminal device 200 is located within the critical distance from the refrigerator 100 based on the location information of the terminal device 200 in operation S550. The critical distance may be changed according to the user settings. When the terminal device 200 is not located within the critical distance from the refrigerator 100 in operation S550-N, the refrigerator 100 may operate in the first mode. The refrigerator 100 may repeat operations S510 to S550.

When the terminal device 200 is located within the critical distance from the refrigerator 100 in operation S550-Y, the refrigerator 100 may operate in the second mode in operation S560. The second mode may mean the low-noise mode.

According to various embodiments, while the refrigerator 100 is operating in the second mode, the refrigerator 100 may determine whether to operate in the first mode in consideration of the location information of the terminal device 200. When the terminal device 200 is located within the critical distance from the refrigerator 100, the refrigerator 100 may maintain the second mode. When the terminal device 200 is not located within the critical distance from the refrigerator 100, the refrigerator 100 may change the second mode to the first mode and operate. Although the entire drawing is described assuming that the refrigerator 100 is operating in the first mode, the refrigerator 100 may determine the mode using the location of the terminal device 200 even in a situation where it is operating in the second mode.

FIG. 6 is a flowchart for describing an operation of acquiring the refrigerator 100 noise based on the audio information according to an embodiment of the disclosure.

Operations S610, S620, S625, S635, S640, S650, and S660 of FIG. 6 may correspond to operations S510, S520, S525, S535, S540, S550, and S560 of FIG. 5. Therefore, a redundant description thereof will be omitted.

After acquiring the audio information, the refrigerator 100 may determine whether the preset frequency is identified in the audio information in operation S631. The refrigerator 100 may analyze various audio signals included in the audio information to identify the preset frequency. The preset frequency may refer to the frequency of the noise generated from the refrigerator. Since the noise from the refrigerator is generated consistently, there may be the unique frequency generated from the refrigerator. Therefore, the refrigerator 100 may store the unique frequency of the refrigerator noise as the preset frequency in the memory 110.

When the preset frequency is not identified in the audio information in operation S631, the refrigerator 100 may operate in the first mode.

When the preset frequency is identified in the audio information in operation S631-Y, the refrigerator 100 may extract an audio signal corresponding to the preset frequency from the audio information in operation S632. The refrigerator 100 may acquire the size of the extracted audio signal.

The refrigerator 100 may identify whether the size of the extracted audio signal is within the error range of the reference noise in operation S633. The refrigerator may store the reference noise in the memory 110. This is because the noise varies depending on the measurement location or mode. Therefore, the refrigerator 100 may determine the reference noise indicating the representative noise value and determine whether the size of the audio signal corresponding to the preset frequency is within the error range of the reference noise.

When the size of the extracted audio signal is not within the error range of the reference noise in operation S633-N, the refrigerator 100 may operate in the first mode. That is, the refrigerator 100 may repeat operations S610 to S633. When the size of the extracted audio signal is not within the error range of the reference noise, the refrigerator 100 may determine that the audio signal is not the noise generated from the refrigerator 100 even though it is a signal corresponding to the preset frequency.

When the size of the extracted audio signal is within the error range of the reference noise in operation S633-Y, the refrigerator 100 may acquire the refrigerator noise corresponding to the preset frequency in operation S634. Thereafter, the refrigerator 100 may perform operations S635 to S660.

FIG. 7 is a table for describing frequency characteristics of a plurality of devices according to an embodiment of the disclosure.

Table 710 of FIG. 7 may include unique characteristic information corresponding to each of the various devices. The frequency of the noise generated from each device may be different. This is because the rotation speed of the motor, etc., is different. The frequency of the noise generated from the device may be different, and the size of the noise may be different. In addition, the size of the noise may be different depending on the location where the noise generated from the device is measured. Therefore, in order to determine whether the noise is generated from a specific device, the refrigerator 100 may use the reference noise and the error range. This is because the noise measured in the audio information may not be the noise generated from the refrigerator 100. Therefore, the refrigerator 100 may identify a noise source based on the table information including the unique feature information. The error range of the reference noise may be described as a preset noise range.

For example, the refrigerator 100 may determine whether there are preset frequencies f1 to f6 in the audio information. When the preset frequency f1 is identified in the audio information, the refrigerator 100 may separately extract an audio signal corresponding to the preset frequency f1. Then, the refrigerator 100 may acquire the size of the extracted audio signal. The refrigerator 100 may determine whether the size of the extracted audio signal is within the error range (10%) of the reference noise xt. When the size of the extracted audio signal is within the error range (10%) of the reference noise xt, the refrigerator 100 may identify the size of the extracted audio signal as noise generated from refrigerator #1 corresponding to the preset frequency f1.

FIG. 8 is a table for describing an operation of estimating a distance based on noise according to an embodiment of the disclosure.

Table 810 of FIG. 8 may represent a reference distance (or estimated distance) corresponding to the reference noise of the refrigerator. Since the location of the refrigerator 100 is fixed, the location of the terminal device 200 may be estimated (or predicted) based on the noise level of the collected audio signal. The louder the refrigerator noise, the closer the terminal device 200 is to the refrigerator 100. The refrigerator 100 may store the table information indicating the reference distance (or estimated distance) corresponding to the noise in the memory 110.

For example, when the refrigerator noise acquired from the audio information is s1, the refrigerator 100 may determine that the terminal device 200 is away from the refrigerator 100 by d1. Also, when the refrigerator noise acquired from the audio information is s6, the refrigerator 100 may determine that the terminal device 200 is away from the refrigerator 100 by d6.

FIG. 9 is a flowchart for describing an operation of requesting the audio information from the terminal device 200 according to an embodiment of the disclosure.

Operations S910, S920, S925, S930, S935, S940, S950, and S960 of FIG. 9 may correspond to operations S510, S520, S525, S530, S535, S540, S550, and S560 of FIG. 5. Therefore, a redundant description thereof will be omitted.

After operating in the first mode, the refrigerator 100 may identify whether a preset event occurs in operation S911. The preset event may mean an event that requires a determination as to whether the change to the low-noise mode (second mode) is necessary. The preset event may mean an event that a user is identified near the refrigerator 100, or an event that performs a high-performance mode in which the refrigerator 100 generates more noise than the general mode.

According to various embodiments, the preset event may mean an event in which the terminal device 200 is recognized by the refrigerator 100 based on a short-range communication method (e.g., Bluetooth). The refrigerator 100 may determine that the preset event has occurred when the terminal device 200 is newly recognized based on the short-range communication method.

According to various embodiments, the preset event may mean an event in which the preset mode is performed. The preset mode may mean a mode in which noise is relatively louder than noise generated while performing the general mode.

When the preset event does not occur in operation S911-N, the refrigerator 100 may perform the first mode. That is, the refrigerator 100 may repeat operations S910 to S911.

When the preset event occurs in operation S911-Y, the refrigerator 100 may transmit the audio information request to the terminal device 200 in operation S912.

The terminal device 200 may receive the audio information request from the refrigerator 100. The terminal device 200 may acquire the audio information through the microphone of the terminal device 200 in operation S920. Thereafter, the terminal device 200 may perform operations S920 to S925, and the refrigerator 100 may perform operations S930 to S960.

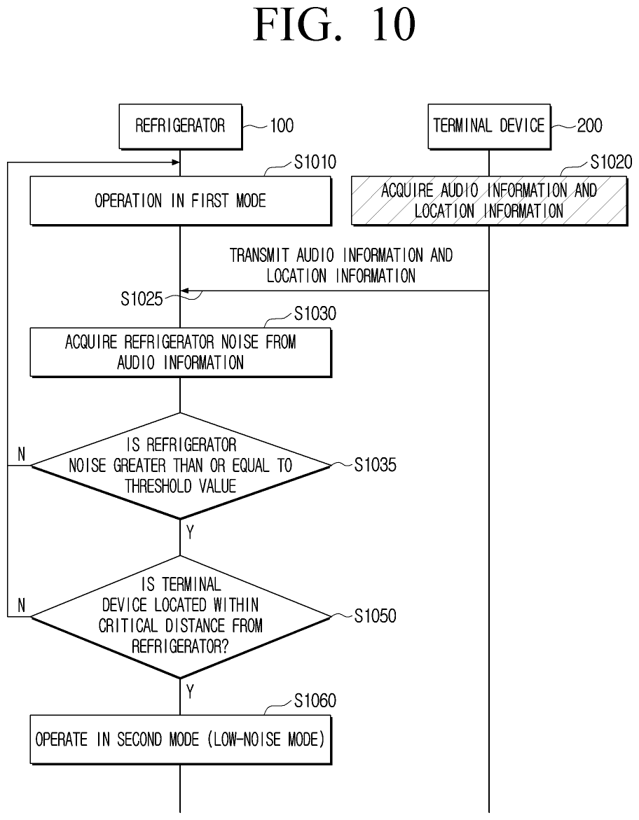

FIG. 10 is a flowchart for describing an operation of controlling the mode of the refrigerator 100 based on the location information received from the terminal device 200 according to an embodiment of the disclosure.

Operations S1010, S1030, S1035, S1050, and S1060 of FIG. 10 may correspond to operations S510, S530, S535, S550, and S560 of FIG. 5. Therefore, a redundant description thereof will be omitted.

The terminal device 200 may acquire the audio information and the location information in operation S1020. The audio information may include an audio signal collected through the microphone of the terminal device 200. The location information may include at least one of information indicating an absolute location of the terminal device 200 or information indicating a relative location of the terminal device 200. The information indicating the absolute location information of the terminal device 200 may mean GPS information. The information indicating the relative location of the terminal device 200 may include a distance from the refrigerator 100 to the terminal device 200 sensed by the terminal device 200 through the sensor. The terminal device 200 may sense the distance from the refrigerator 100 to the terminal device 200 using at least one of a distance sensor and an image sensor.

The terminal device 200 may transmit the acquired audio information and the location information to the refrigerator 100 in operation S1025.

The refrigerator 100 may receive the audio information and the location information from the terminal device 200. The refrigerator 100 may acquire the refrigerator noise from the audio information in operation S1030. Then, the refrigerator 100 may identify whether the refrigerator noise is greater than or equal to the threshold value in operation S1035. When the refrigerator noise is not greater than or equal to the threshold value in operation S1035-N, the refrigerator 100 may operate in the first mode. That is, the refrigerator 100 may repeat operations S1010 to S1035.

When the refrigerator noise is greater than or equal to the threshold value in operation S1035-Y, the refrigerator 100 may identify whether the terminal device 200 is located within the critical distance from the refrigerator 100 based on the location information in operation S1050.

When the terminal device 200 is not located within the critical distance from the refrigerator 100 in operation S1050-N, the refrigerator 100 may operate in the first mode. The refrigerator 100 may repeat operations S1010 to S1050. When the terminal device 200 is located within the critical distance from the refrigerator 100 in operation S1050-N, the refrigerator 100 may operate in the second mode in operation S1060.

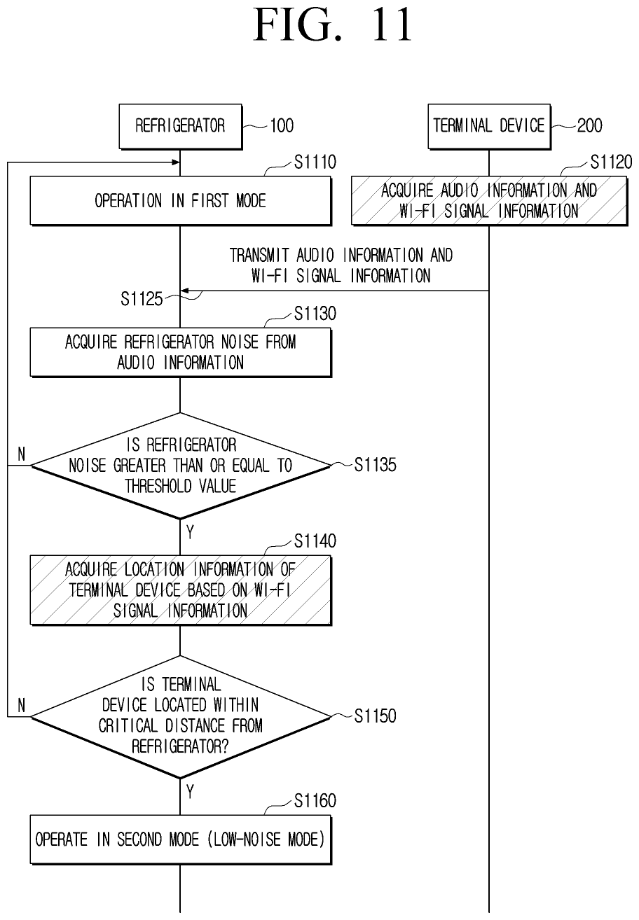

FIG. 11 is a flowchart for describing an operation of controlling a mode of the refrigerator 100 based on Wi-Fi signal information received from the terminal device 200 according to an embodiment of the disclosure.

Operations S1110, S1130, S1135, S1150, and S1160 of FIG. 11 may correspond to operations S510, S530, S535, S550, and S560 of FIG. 5. Therefore, a redundant description thereof will be omitted.

The terminal device 200 may acquire the audio information and the Wi-Fi signal information in operation S1120. The Wi-Fi signal information may include the strength of the Wi-Fi signal received through the router 300. The terminal device 200 may transmit the audio information and the Wi-Fi signal information to the refrigerator 100 in operation S1125.

The refrigerator 100 may receive the audio information and the Wi-Fi signal information from the terminal device 200. Then, the refrigerator 100 may perform operations S1130 to S1135.

When the refrigerator noise is greater than or equal to the threshold value in operation S1135-Y, the refrigerator 100 may acquire the location information of the terminal device 200 based on the Wi-Fi signal information in operation S1140. The strength of the Wi-Fi signal may be used to identify the location of the user. The locations of the refrigerator 100 and the router 300 are fixed. The refrigerator 100 may pre-store the location of the refrigerator 100 and the location of the router 300 in the memory 110. Therefore, the strength of the Wi-Fi signal transmitted from the router 300 may indicate the distance from the router 300 to the terminal device 200. As the strength of the Wi-Fi signal increases, it may be indicated that the terminal device 200 is approaching the router 300. The refrigerator 100 may identify (or estimate) the location of the terminal device 200 through the strength of the Wi-Fi signal.

The refrigerator 100 may perform operations S1150 to S1160 based on the location information of the terminal device 200.

FIG. 12 is a flowchart for describing an operation of controlling the mode of the refrigerator 100 when the user conversation is identified according to an embodiment of the disclosure.

Operations S1210, S1220, S1225, S1230, S1235, S1240, S1250, and S1260 of FIG. 12 may correspond to operations S510, S520, S525, S530, S535, S540, S550, and S560 of FIG. 5. Therefore, a redundant description thereof will be omitted.

When the terminal device 200 is located within the critical distance from the refrigerator 100 in operation S1250-Y, the refrigerator 100 may determine whether the user conversation is identified in the audio information in operation S1255. When the user conversation is not identified in the audio information in operation S1255-N, the refrigerator 100 may operate in the first mode. That is, the refrigerator 100 may repeat operations S1210 to S1255. When the user conversation is identified in the audio information in operation S1255-Y, the refrigerator 100 may operate in the second mode in operation S1260.

FIG. 13 is a flowchart for describing an operation of identifying the user conversation based on voiceprint information according to an embodiment of the disclosure.

Operations S1310, S1320, S1325, S1330, S1335, S1340, S1350, and S1360 of FIG. 13 may correspond to operations S510, S520, S525, S530, S535, S540, S550, and S560 of FIG. 5. Therefore, a redundant description thereof will be omitted.

When the terminal device 200 is located within the critical distance from the refrigerator 100 in operation S1350-Y, the refrigerator 100 may transmit the voiceprint information request to the terminal device 200 in operation S1351. The voiceprint information may be the voiceprint information of a preset user using the terminal device 200.

The terminal device 200 may receive the voiceprint information request from the refrigerator 100. The terminal device 200 may transmit the voiceprint information stored in the memory of the terminal device 200 to the refrigerator 100 in operation S1352.

The refrigerator 100 may receive the voiceprint information from the terminal device 200. The refrigerator 100 may determine whether the user conversation is identified in the audio information based on the voiceprint information received from the terminal device 200 in operation S1355. The voiceprint information may include information that may specify the user's voice. Therefore, the refrigerator 100 may determine whether the user's voice of the terminal device 200 is included in the audio information based on the received voiceprint information.

When the user conversation is not identified in the audio information in operation S1355-N, the refrigerator 100 may operate in the first mode. That is, the refrigerator 100 may repeat operations S1310 to S1355.

When the user conversation is identified in the audio information in operation S1355-Y, the refrigerator 100 may identify whether the conversation time is greater than or equal to the critical time in operation S1356. The refrigerator 100 may acquire the user conversation time based on the audio information and the voiceprint information. When the conversation time is not identified to be greater than or equal to the critical time in operation S1356-N, the refrigerator 100 may operate in the first mode. That is, the refrigerator 100 may repeat operations S1310 to S1355. Even if the audio information includes the user conversation, when the conversation time is not continuous, the refrigerator 100 may maintain the current first mode.

When the conversation time is identified to be greater than or equal to the critical time in operation S1356-Y, the refrigerator 100 may operate in the second mode in operation S1360. The critical time may change according to the user settings. According to various embodiments, when the user conversation is identified, the audio information may be acquired in real time from the terminal device 200. The refrigerator 100 may acquire the audio information in real time to determine whether the user conversation continues. The refrigerator 100 may operate in the second mode until the user conversation is no longer identified. When the user conversation is no longer identified, the refrigerator 100 may change the second mode back to the first mode and operate.

FIG. 14 is a flowchart for describing an operation for controlling temperature maintenance of the refrigerator 100 according to an embodiment of the disclosure.

Operations S1410, S1420, S1425, S1430, S1435, S1440, S1450, and S1460 of FIG. 14 may correspond to operations S510, S520, S525, S530, S535, S540, S550, and S560 of FIG. 5. Therefore, a redundant description thereof will be omitted.

After operating in the second mode, the refrigerator 100 may acquire the current temperature of the refrigerator in operation S1470. The refrigerator 100 may acquire the current temperature in real time. Since the second mode corresponds to the low-noise mode, there is a possibility that the indoor temperature of the refrigerator may rise. Therefore, the refrigerator 100 may identify whether the current temperature is lower than or equal to the critical temperature in operation S1471. The critical temperature may mean the minimum temperature for maintaining the refrigeration function that should be provided to the consumer through the refrigerator 100.

When the current temperature is lower than or equal to the critical temperature in operation S1471-Y, the refrigerator 100 may maintain the second mode. That is, the refrigerator 100 may repeat operations S1460 to S1471. When the current temperature is not lower than or equal to the critical temperature in operation S1471-N, the refrigerator 100 may operate in the first mode. That is, the refrigerator 100 may repeat operations S1410 to S1471. Since maintaining the refrigeration function is a more important issue than reducing the noise perceived by the user by operating in the low-noise mode, the refrigerator 100 may determine the operation mode in consideration of the critical temperature.

FIG. 15 is a flowchart for describing an operation of comparing the environmental noise and the refrigerator 100 noise according to an embodiment of the disclosure.

Operations S1510, S1520, S1525, S1530, S1540, S1550, and S1560 of FIG. 15 may correspond to operations S510, S520, S525, S530, S540, S550, and S560 of FIG. 5. Therefore, a redundant description thereof will be omitted.

After acquiring the refrigerator noise, the refrigerator 100 may acquire the environmental noise from the audio information in operation S1531. The environmental noise may mean the noise represented by the audio signal collected from the terminal device 200. The environmental noise may be described as background noise or overall noise. The environmental noise may represent all types of noise, but the refrigerator noise may represent only the noise generated from the refrigerator 100.

The refrigerator 100 may acquire the difference value between the environmental noise and the refrigerator noise in operation S1532. The difference value may mean the value acquired by subtracting the refrigerator noise from the environmental noise. It may be identified whether the difference value between the environmental noise and the refrigerator noise is less than the threshold value in operation S1533.

When the difference value between the environmental noise and the refrigerator noise is not less than the threshold value in operation S1533-N, the refrigerator 100 may operate in the first mode. That is, the refrigerator 100 may repeat operations S1510 to S1533. When the difference value between the environmental noise and the refrigerator noise is less than the threshold value, the refrigerator 100 may determine that the refrigerator noise does not cause discomfort to the user.

When the difference value between the environmental noise and the refrigerator noise is less than the threshold value in operation S1533-Y, the refrigerator 100 may perform operations S1540 to S1560.

FIG. 16 is a flowchart for describing an operation of controlling the mode of the refrigerator 100 in consideration of the ratio of the environmental noise and the refrigerator 100 noise according to an embodiment of the disclosure.

Operations S1610, S1620, S1625, S1630, S1640, S1650, and S1660 of FIG. 16 may correspond to operations S510, S520, S525, S530, S540, S550, and S560 of FIG. 5. Therefore, a redundant description thereof will be omitted.

After acquiring the refrigerator noise, the refrigerator 100 may acquire the environmental noise from the audio information in operation S1631. The environmental noise may mean the noise represented by the audio signal collected from the terminal device 200. The environmental noise may be described as background noise or overall noise. The environmental noise may represent all types of noise, but the refrigerator noise may represent only the noise generated from the refrigerator 100.

The refrigerator 100 may acquire the ratio of the refrigerator noise in the environmental noise in operation S1632. The refrigerator 100 may identify whether the acquired ratio is greater than or equal to the critical ratio in operation S1633.

When the acquired ratio is not greater than or equal to the critical ratio in operation S1633-N, the refrigerator 100 may operate in the first mode. That is, the refrigerator 100 may repeat operations S1610 to S1633. When the acquired ratio is not greater than or equal to the critical ratio, the refrigerator 100 may predict that the refrigerator noise will not be loud to the user.

When the acquired ratio is greater than or equal to the critical ratio in operation S1633-Y, the refrigerator 100 may perform operations S1640 to S1660.

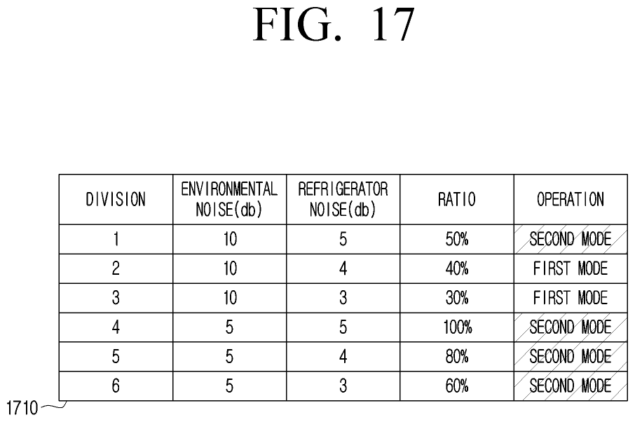

FIG. 17 is a figure for describing the ratio of the environmental noise and the refrigerator 100 noise according to an embodiment of the disclosure.

Table 1710 of FIG. 17 shows the process of calculating the ratio of the environmental noise occupied by the refrigerator noise. When the environmental noise is 10 dB and the refrigerator noise is 5 dB, the refrigerator 100 may determine the ratio of the refrigeration noise occupied by the environmental noise as 50%. The critical ratio is assumed to be 50%. Therefore, the refrigerator 100 may operate in the second mode.

When the environmental noise is 10 dB and the refrigerator noise is 4 dB, the refrigerator 100 may determine the ratio of the environmental noise occupied by the environmental noise as 40%. Therefore, the refrigerator 100 may operate in the first mode.

When the environmental noise is 5 dB and the refrigerator noise is 3 dB, the refrigerator 100 may determine the ratio of the refrigeration noise occupied by the environmental noise as 60%. Therefore, the refrigerator 100 may operate in the second mode.

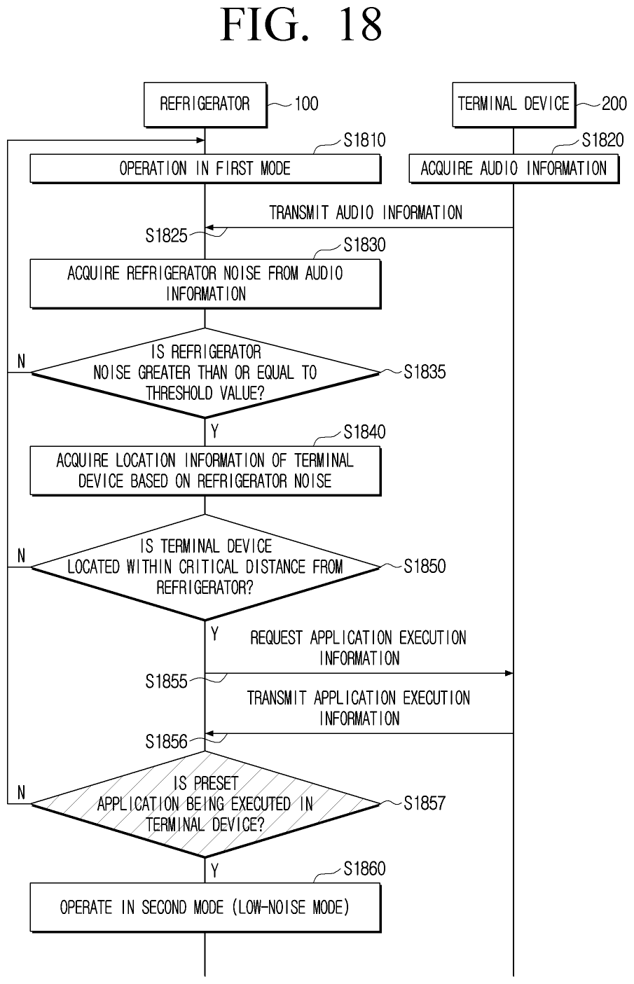

FIG. 18 is a flowchart for describing an operation of controlling the mode of the refrigerator 100 according to an application running on the terminal device 200 according to an embodiment of the disclosure.

Operations S1810, S1820, S1825, S1830, S1835, S1840, S1850, and S1860 of FIG. 18 may correspond to operations S510, S520, S525, S530, S535, S540, S550, and S560 of FIG. 5. Therefore, a redundant description thereof will be omitted.

When the terminal device 200 is located within the critical distance from the refrigerator 100 in operation S1850-Y, the application execution information request may be transmitted to the terminal device 200 in operation S1855. The application execution information may include a currently running application item.

The terminal device 200 may transmit the application execution information request from the refrigerator 100 in operation S1856. The terminal device 200 may transmit the application execution information to the refrigerator 100 in operation S1856.

The refrigerator 100 may receive the application execution information from the terminal device 200. Then, the refrigerator 100 may determine whether the preset application is being executed in the terminal device 200 based on the application execution information in operation S1857. When the preset application is not being executed in the terminal device 200 in operation S1857-N, the refrigerator 100 may operate in the first mode. That is, the refrigerator 100 may repeat operations S1810 to S1857.

When the preset application is running on the terminal device 200 in operation S1857-Y, the refrigerator 100 may operate in the second mode in operation S1860. When the preset application is running on the terminal device 200, the refrigerator 100 may determine that it is necessary to provide the low-noise mode to the user. The preset application may refer to an application that is run in a situation where the user should concentrate.

For example, the preset application may include at least one of a dictionary application, a lecture application, a financial application, or a phone application.

According to various embodiments, the preset application may be a phone application. The refrigerator 100 may determine whether the user of the terminal device 200 is on a phone call based on the received application execution information. When the phone application is running for the user of the terminal device 200 to make a phone call, the refrigerator 100 may operate in the second mode.

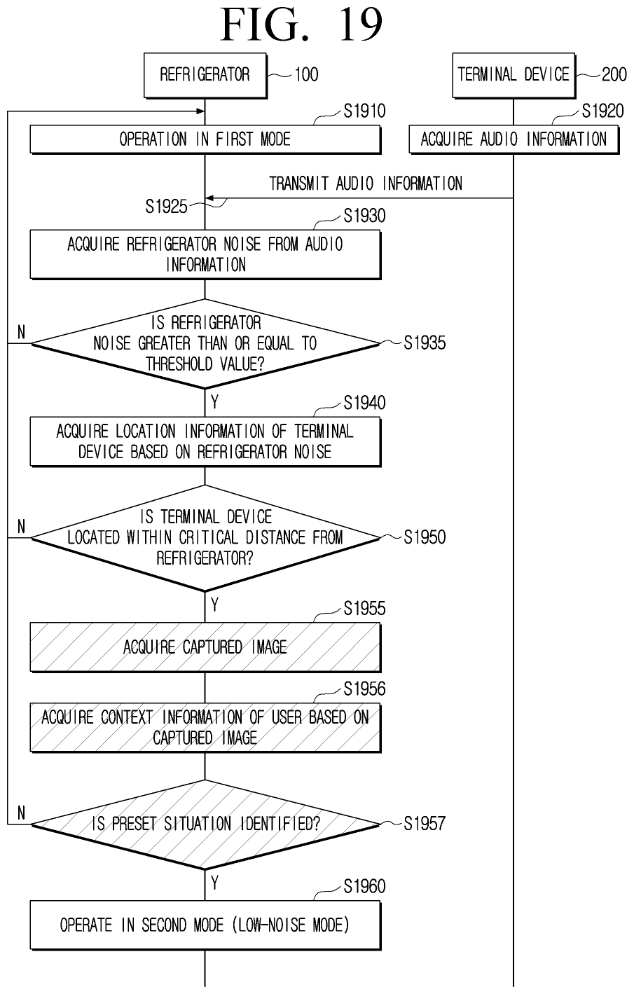

FIG. 19 is a flowchart for describing an operation of analyzing user context information based on a captured image according to an embodiment of the disclosure.

Operations S1910, S1920, S1925, S1930, S1935, S1940, S1950, and S1960 of FIG. 19 may correspond to operations S510, S520, S525, S530, S535, S540, S550, and S560 of FIG. 5. Therefore, a redundant description thereof will be omitted.

When the terminal device 200 is located within the critical distance from the refrigerator 100 in operation S1950-Y, the refrigerator 100 may acquire a captured image in operation S1955. The refrigerator 100 may acquire the captured image through a camera. The captured image may include a user of the terminal device 200.

The refrigerator 100 may acquire user context information based on the captured image in operation S1956. The refrigerator 100 may analyze the captured image to determine whether the user is in a certain situation. The context information may mean information indicating the user's activity. For example, the context information may mean information indicating watching TV, cleaning, sleeping, reading, exercising, etc.

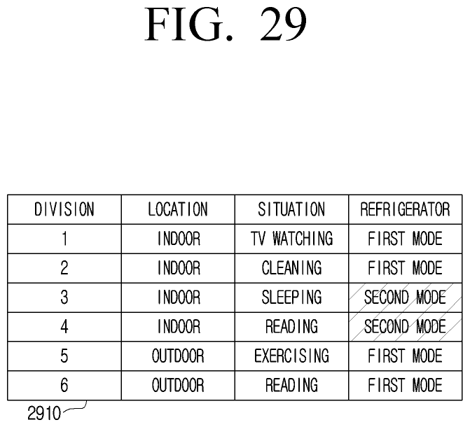

The refrigerator 100 may determine whether the preset situation is identified based on the context information in operation S1957. When the preset situation is not identified in operation S1957-N, the refrigerator 100 may operate in the first mode. That is, the refrigerator 100 may repeat operations S1910 to S1957. When the preset situation is identified in operation S1957-Y, the refrigerator 100 may operate in the second mode in operation S1960. A specific example related to this is described in FIG. 29.

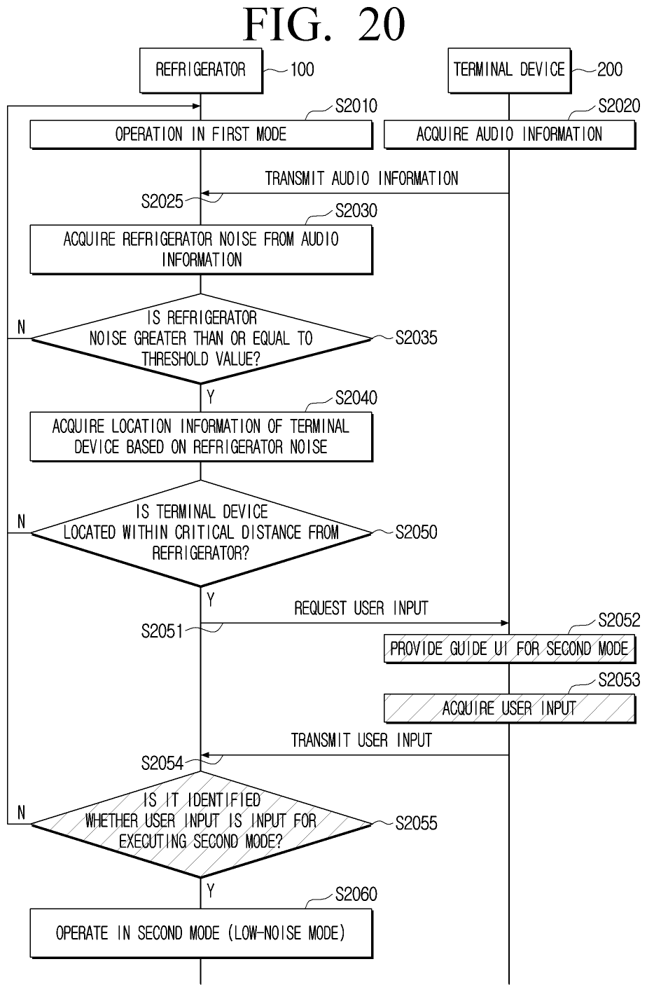

FIG. 20 is a flowchart explaining an operation of providing a UI for changing the mode of the refrigerator 100 according to an embodiment of the disclosure.

Operations S2010, S2020, S2025, S2030, S2035, S2040, S2050, and S2060 of FIG. 20 may correspond to operations S510, S520, S525, S530, S535, S540, S550, and S560 of FIG. 5. Therefore, a redundant description thereof will be omitted.

When the terminal device 200 is located within the critical distance from the refrigerator 100 in operation S2050-Y, the refrigerator 100 may transmit the user input request to the terminal device 200 in operation S2051. Here, the user input request may be a request for a user command for controlling in the second mode (low-noise mode).

The terminal device 200 may receive the user input request from the refrigerator 100. The terminal device 200 may provide a guide UI for the second mode in operation S2052. The terminal device 200 may acquire user input through the guide UI in operation S2053.

According to various embodiments, the terminal device 200 may display the guide UI in the form of the image on the display of the terminal device 200. According to various embodiments, the terminal device 200 may output the guide UI in the form of audio to the speaker of the terminal device 200.

According to various embodiments, the terminal device 200 may receive user input in the form of a touch input. In addition, the terminal device 200 may receive a user input in the form of a voice input. The terminal device 200 may transmit the user input to the refrigerator 100 in operation S2054.

The refrigerator 100 may receive the user input from the terminal device 200. The refrigerator 100 may identify whether the user input received from the terminal device 200 is an input for executing the second mode in operation S2055.

When the received user input is not an input for executing the second mode in operation S2055-N, the refrigerator 100 may operate in the first mode in operation S2010. That is, the refrigerator 100 may repeat operations S2010 to S2055. When the received user input is an input for executing the second mode in operation S2055-Y, the refrigerator 100 may operate in the second mode.

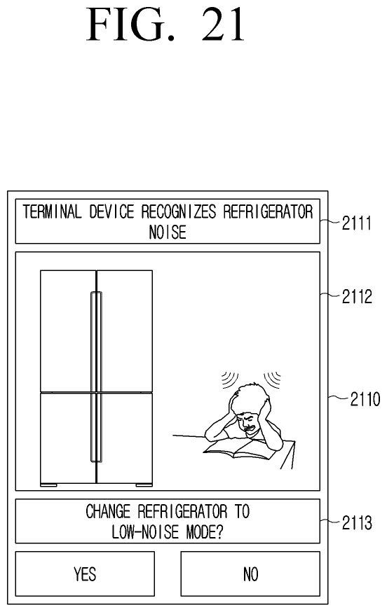

FIG. 21 is a diagram for describing a UI for changing the mode of the refrigerator 100 according to an embodiment of the disclosure.

A UI 2110 of FIG. 21 may represent a UI for guiding a user input for executing the second mode. The UI 2110 may include at least one of text information 2111 indicating that noise of the refrigerator 100 is recognized in the terminal device 200, image information 2112 indicating that noise of the refrigerator 100 is recognized in terminal device 200, or text information 2113 requesting user input on whether to operate terminal device 200 in low-noise mode.

The UI 2110 guiding the user input may be provided to the user in at least one of the refrigerator 100 and the terminal device 200. The user may input the user input indicating whether to execute the low-noise mode in at least one of the refrigerator 100 and the terminal device 200.

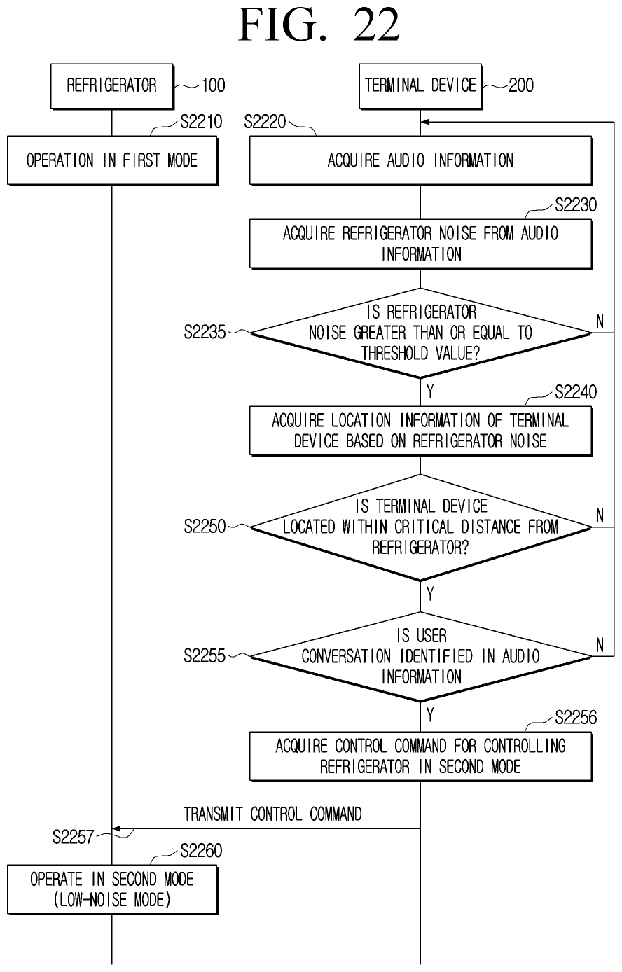

FIG. 22 is a flowchart for describing an embodiment in which the main operations are performed in the terminal device 200 according to an embodiment of the disclosure.

FIG. 22 illustrates an embodiment in which the operations of the refrigerator 100 described in FIG. 12 are performed in the terminal device 200. Although not described in FIG. 22, the operations of the refrigerator 100 described in other drawings may be performed in the terminal device 200.

The refrigerator 100 may operate in the first mode in operation S2210. In addition, the terminal device 200 may acquire the audio information in operation S2220. The terminal device 200 may acquire the refrigerator noise from the audio information in operation S2230. The terminal device 200 may identify whether the refrigerator noise is greater than or equal to the threshold value in operation S2235. When the refrigerator noise is greater than or equal to the threshold value in operation S2235-Y, the terminal device 200 may acquire the location information of the terminal device 200 based on the refrigerator noise in operation S2240.

The terminal device 200 may identify whether the terminal device 200 is located within the critical distance from the refrigerator 100 based on the location information of the terminal device 200 in operation S2250. When the terminal device 200 is not located within the critical distance from the refrigerator 100 in operation S2250-N, the terminal device 200 may acquire the audio information. That is, the terminal device 200 may repeat operations S2220 to S2250.

When the terminal device 200 is located within the critical distance from the refrigerator 100 in operation S2250-Y, the terminal device 200 may determine whether the user conversation is identified in the audio information in operation S2255. When the user conversation is not identified in the audio information in operation S2255-N, the terminal device 200 may acquire the audio information. That is, the terminal device 200 may repeat operations S2220 to S2250.

When the user conversation is identified in the audio information in operation S2255-Y, the terminal device 200 may acquire (or generate) a control command for controlling the refrigerator 100 in the second mode in operation S2256. The terminal device 200 may transmit the control command to the refrigerator 100 in operation S2257.

The refrigerator 100 may receive the control command from the terminal device 200. The refrigerator 100 may operate in the second mode based on the control command in operation S2260.

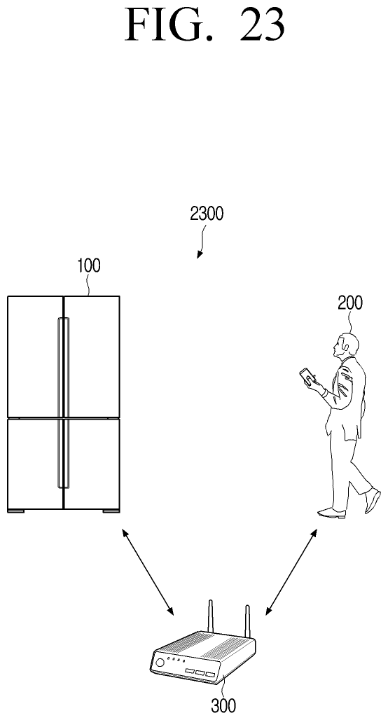

FIG. 23 is a diagram for describing a system including the refrigerator 100, the terminal device 200, and the router 300 according to an embodiment of the disclosure.

The system 2300 may include the refrigerator 100, the terminal device 200, and the router 300. The router 300 may connect each of the refrigerator 100 and the terminal device 200. In addition, the router 300 may relay communication between the refrigerator 100 and the terminal device 200. For example, the router 300 may receive the audio information acquired from the terminal device 200 from the terminal device 200 and transmit the received audio information to the refrigerator 100.

The router 300 may mean a device that relays information to configure a home network. The terminal device 200 may communicate with the router 300 via the Wi-Fi. In addition, the refrigerator 100 may also communicate with the router 300 via the Wi-Fi.

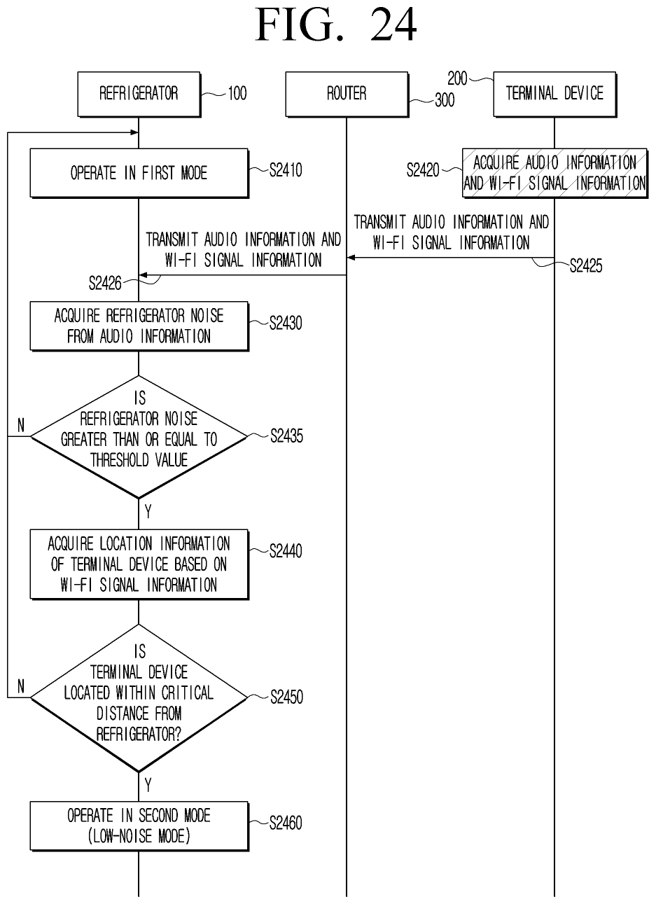

FIG. 24 is a flowchart for describing an operation of controlling a mode of the refrigerator 100 in a system including the refrigerator 100, the terminal device 200, and the router 300 according to an embodiment of the disclosure.

Operations S2410, S2430, S2435, S2440, S2450, and S2460 of FIG. 24 may correspond to operations S1110, S1130, S1135, S1140, S1150, and S1160 of FIG. 11. Therefore, a redundant description thereof will be omitted.

Unlike the embodiment of FIG. 11, the embodiment of FIG. 24 may use Wi-Fi signal information instead of the location information to control the mode of the refrigerator 100. Specifically, the terminal device 200 may acquire the audio information and the Wi-Fi signal information in operation S2420. The Wi-Fi signal information is described in FIG. 11. The terminal device 200 may transmit the audio information and the Wi-Fi signal information to the router 300 in operation S2425.

The router 300 may receive the audio information and the Wi-Fi signal information through the terminal device 200. Then, the router 300 may transmit the received the audio information and the Wi-Fi signal information to the refrigerator 100 in operation S2426.

The refrigerator 100 may receive the audio information and the Wi-Fi signal information from the router 300. Thereafter, the refrigerator 100 may perform operations S2430 to S2460.

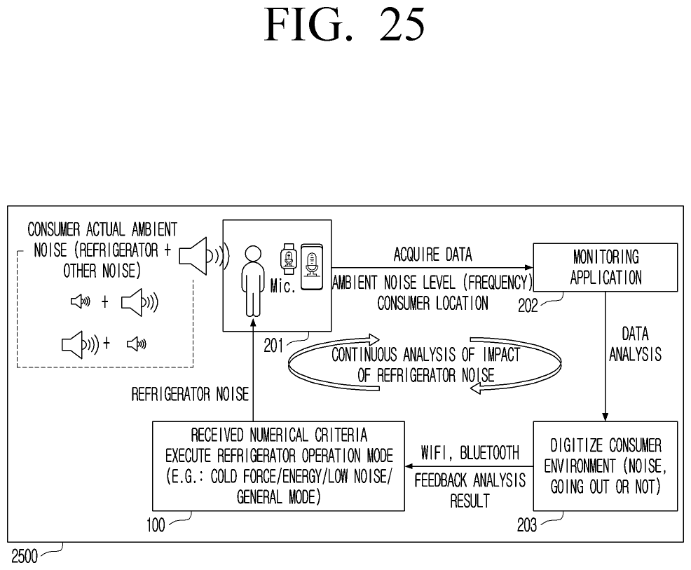

FIG. 25 is a diagram for describing a process of analyzing the impact of the refrigerator 100 noise according to an embodiment of the disclosure.

Referring to the embodiment 2500 of FIG. 25, the terminal device 200 may include at least one of a sensor unit 201, a monitoring application 202, or a data digitization module 203.

The sensor unit 201 may sense various types of information related to the user. The sensor unit 201 may include at least one of a microphone or a position sensor. The sensor unit 201 may collect the refrigerator noise through the microphone. In addition, the sensor unit 201 may collect the user location through the distance sensor. The sensor unit 201 may transmit data related to ambient noise or data related to the user location to the monitoring application 202.

The monitoring application 202 may store the sensing data received from the sensor unit 201. In addition, the monitoring application 202 may transmit the sensing data to the data digitization module 203 to analyze the sensing data.

The data digitization module 203 may digitize the sensing data received from the monitoring application 202. Here, the data digitization may mean analyzing the sensing data and changing the information represented by each sensing data into a form that may be analyzed by the refrigerator 100. The data digitization module 203 may be described as an analysis module. The data digitization module 203 may transmit the analysis result of analyzing the sensing data to the refrigerator 100. Here, the data digitization module 203 may transmit the analysis result to the refrigerator 100 using a Wi-Fi or Bluetooth method.

The refrigerator 100 may receive the analysis result from the data digitization module 203 included in the terminal device 200. Then, the refrigerator 100 may determine whether to operate in a mode based on the analysis result. Then, the refrigerator 100 may operate in the determined operation mode. When the refrigerator 100 operates in the determined mode, the refrigerator noise may occur depending on the operation result. The sensor unit 201 included in the terminal device 200 may repeatedly analyze the refrigerator noise again.

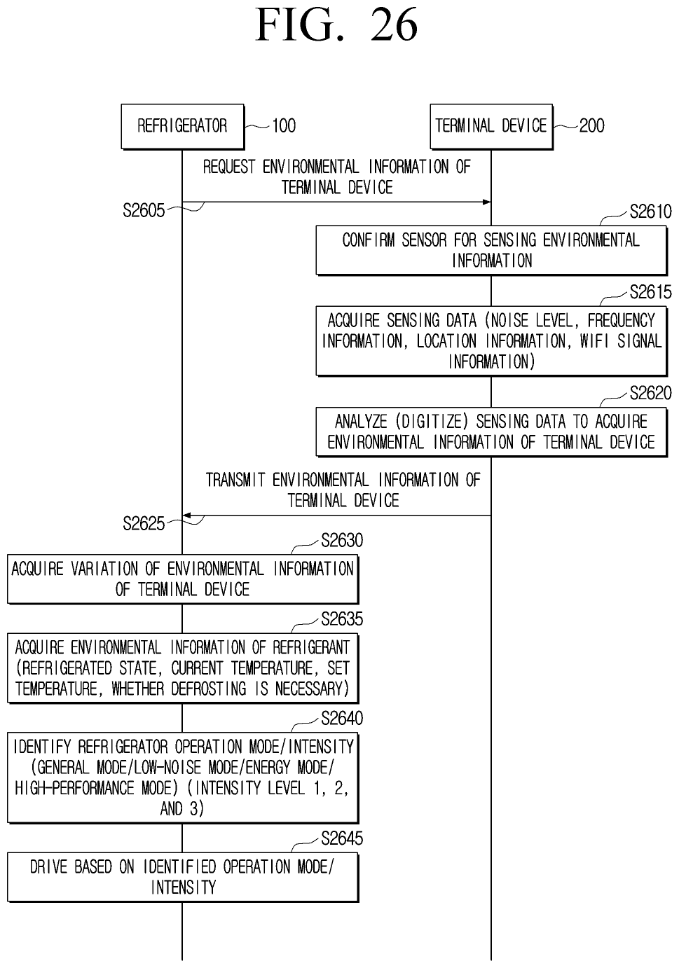

FIG. 26 is a flowchart for describing an operation of controlling the mode and intensity of the refrigerator 100 according to an embodiment of the disclosure.

Referring to FIG. 26, the refrigerator 100 may transmit the environmental information request of the terminal device 200 to the terminal device 200 in operation S2605. The environmental information request may mean the control command requesting to collect and transmit the environmental information collected by the terminal device 200.

The terminal device 200 may receive an environmental information request from the refrigerator 100. The terminal device 200 may identify a sensor for sensing the environmental information in operation S2610. When the environmental information is the audio information, the terminal device 200 may use a microphone sensor. In addition, when the environmental information is the user's location information, the terminal device 200 may use a location sensor (or distance sensor).

The terminal device 200 may acquire sensing data through the identified (or determined) sensor in operation S2615. The sensing data may mean at least one of the noise level, the frequency information, the location information, and the Wi-Fi signal information.

The terminal device 200 may acquire the environmental information of the terminal device by analyzing (or digitizing) the collected sensing data in operation S2620. The terminal device 200 may transmit the environmental information (or analysis result) to the refrigerator 100 in operation S2625.

The refrigerator 100 may receive the environmental information of the terminal device 200 from the terminal device 200. The refrigerator 100 may acquire the environmental information change amount of the terminal device 200 by receiving the received environmental information for a critical time in operation S2630.

The refrigerator 100 may acquire the environmental information of the refrigerator 100 in operation S2635. Here, the environmental information of the refrigerator 100 may mean the refrigeration state of the refrigerator 100, the current temperature, the set temperature, whether defrosting is necessary, etc.

The refrigerator 100 may identify the operation mode of the refrigerator and the intensity corresponding to the operation mode based on the environmental information of the terminal device 200 and the environmental information of the refrigerator 100 in operation S2640. The operation mode may include a normal mode, a low-noise mode, an energy mode, a high-performance mode, etc. The normal mode may be a mode that is performed by default when no separate event occurs. The low-noise mode may mean a mode for lowering noise to lower than or equal to the threshold value. The energy mode may mean a mode for increasing energy efficiency above the threshold value. The high-performance mode may mean a mode for lowering the current temperature to less than the critical temperature for a critical time.

Each mode may include multiple stages. For example, the normal mode may include a normal mode of a first stage, a normal mode of a second stage, and a normal mode of a third stage. In addition, the low-noise mode may include a low-noise mode of the first stage, a low-noise mode of the second stage, and a low-noise mode of the third stage. Each stage may indicate that different settings are applied to the refrigerator 100 in relation to performance.

The refrigerator 100 may be driven based on the identified operation mode/intensity in operation S2645.

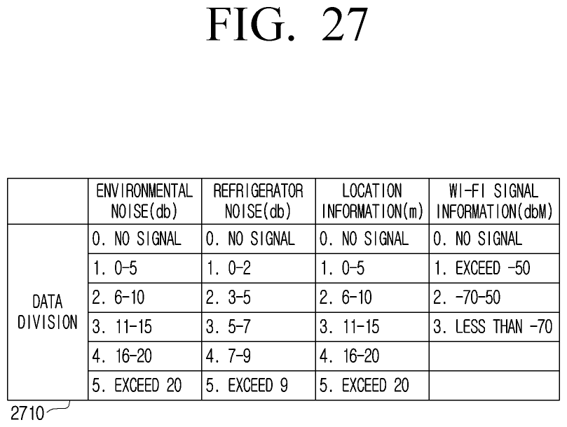

FIG. 27 is a figure for describing an operation of distinguishing sensing data according to an embodiment of the disclosure.

Table 2710 of FIG. 27 may mean a reference table for distinguishing sensing data of the terminal device 200. The refrigerator 100 may digitize the sensing data based on the table 2710.

When the environmental noise is within 0 to 5 dB, the refrigerator 100 may determine that the environmental noise is at level 1. When the environmental noise exceeds 20 dB, the refrigerator 100 may determine that the environmental noise is at level 5.

When the refrigerator noise is within 0 to 2 dB, the refrigerator 100 may determine that the refrigerator noise is at a first level. When the refrigerator noise exceeds 9 dB, the refrigerator 100 may determine that the refrigerator noise is at a fifth level.

When the location information (the distance from the refrigerator 100 to the terminal device 200) is within 0 to 5 m, the refrigerator 100 may determine that the location information is at the first level. When the location information exceeds 20 m, the refrigerator 100 may determine that the location information is at the fifth level.

When the Wi-Fi signal strength exceeds −50 dBM, the refrigerator 100 may determine that the Wi-Fi signal information is at the first level. When the Wi-Fi signal strength is less than −70 dBM, the refrigerator 100 may determine that the Wi-Fi signal information is at the third level. The higher the level, the stronger the signal.

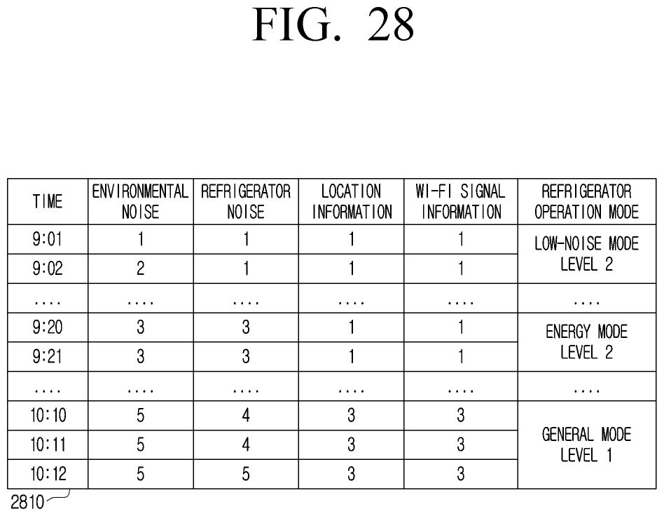

FIG. 28 is a table for describing the sensing data used to control the refrigerator 100 according to an embodiment of the disclosure.

Table 2810 of FIG. 28 shows information that digitizes the sensing data according to table 2710 of FIG. 27. In addition, the table 2810 may indicate in which mode the refrigerator 100 will be controlled based on the digitized environmental information.

Based on the data sensed at 9:01, the refrigerator 100 may determine that the environmental noise is at the first level, the refrigerator noise is at the first level, the location information is at the first level, and the Wi-Fi signal information is at the first level. The refrigerator 100 may operate in the second stage of the low-noise mode.

Based on the data sensed at 10:12, the refrigerator 100 may determine that the environmental noise is at the fifth level, the refrigerator noise is at the fifth level, the location information is at the third level, and the Wi-Fi signal information is at the third level. The refrigerator 100 may operate in the second stage of the normal mode. Here, the location information and the Wi-Fi signal information mean that the terminal device 200 is far away from the refrigerator 100. Nevertheless, the fact that the refrigerator noise is measured at the fifth level may mean that noise from a separate device, not the refrigerator 100, is measured. To solve this problem, the refrigerator 100 may determine the operation mode by giving priority (or weight) to the location information or the Wi-Fi signal information indicating the location of the terminal device 200 over the refrigerator noise.

FIG. 29 is a figure for describing the process of controlling the refrigerator 100 according to context information according to an embodiment of the disclosure.

Table 2910 of FIG. 29 shows an operation mode of the refrigerator determined according to various situations. When the location of the terminal device 200 is indoors and the user is watching TV, the refrigerator 100 may operate in the first mode. In addition, when the location of the terminal device 200 is indoors and the user is cleaning, the refrigerator 100 may operate in the first mode. In addition, when the location of the terminal device 200 is indoors and the user is sleeping, the refrigerator 100 may operate in the second mode. In addition, when the location of the terminal device 200 is indoors and the user is reading, the refrigerator 100 may operate in the second mode. In addition, when the location of the terminal device 200 is outdoors and the user is exercising, the refrigerator 100 may operate in the first mode. In addition, when the location of the terminal device 200 is outdoors and the user is reading, the refrigerator 100 may operate in the first mode.

Indoors may mean that the terminal device 200 is located within the critical distance from the refrigerator 100. Outdoors may mean that the terminal device 200 is not located within a critical distance from refrigerator 100.

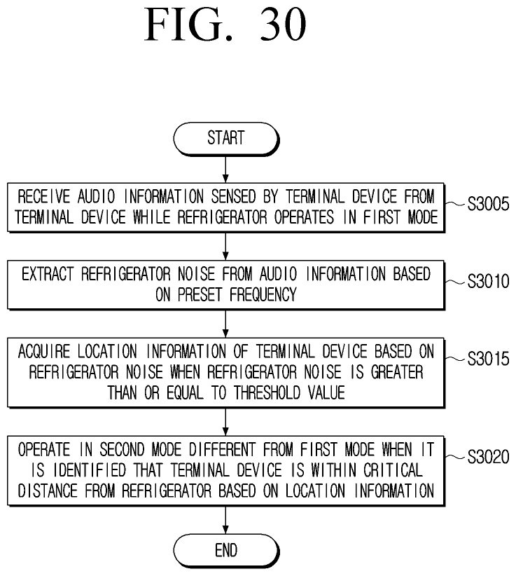

FIG. 30 is a flowchart for describing a control method of a refrigerator 100 according to an embodiment of the disclosure.

Referring to FIG. 30, the control method of a refrigerator, which stores the preset frequency of the refrigerator and communicates with the terminal device, includes receiving the audio information sensed by the terminal device from the terminal device while the refrigerator operates in the first mode in operation S3005, extracting the refrigerator noise from the audio information based on the preset frequency in operation S3010, acquiring the location information of the terminal device based on the refrigerator noise when the refrigerator noise is greater than or equal to the threshold value in operation S3015, and operating the refrigerator in the second mode different from the first mode when the terminal device is identified as being within the critical distance from the refrigerator based on the location information in operation S3020.

Meanwhile, the second mode may be a low-noise mode that generates less noise than the noise generated in the first mode.

Meanwhile, the refrigerator stores a reference noise corresponding to the preset frequency and an error range corresponding to the preset frequency, and in the operation S3010 of extracting the refrigerator noise, an audio signal corresponding to the preset frequency among a plurality of noises included in the audio information is extracted, and when the size of the extracted audio signal is within the error range of the reference noise, the extracted audio signal may be determined as the refrigerator noise.

Meanwhile, in the operation S3010 of extracting the refrigerator noise, the refrigerator noise may be extracted from the audio information based on the preset frequency and the preset signal waveform.

Meanwhile, the refrigerator stores a distance estimation table indicating a distance corresponding to the refrigerator noise, and in the operation S3015 of acquiring the location information, the distance corresponding to the refrigerator noise is acquired as the location information of the terminal device based on the distance estimation table, and in the operation S3020 of operating the refrigerator in the second mode operation S3020, the refrigerator may operate in the second mode when the distance is identified as being within the critical distance.

Meanwhile, the control method may further include an operation of transmitting the control signal requesting the audio information to the terminal device 200 when the preset event occurs, and the preset event may be an event identified as being connectable to the terminal device.

Meanwhile, the operation S3020 of operating the refrigerator in the second mode may include identifying whether the audio information includes the user conversation when the terminal device is within the critical distance from the refrigerator, and when the audio information includes the user conversation, the refrigerator may operate in the second mode.

Meanwhile, the control method may further include transmitting the control signal requesting the voiceprint information stored in the terminal device to the terminal device when the terminal device is within the critical distance from the refrigerator, and identifying whether the audio information includes the user conversation based on the voiceprint information when the voiceprint information is received from the terminal device.

Meanwhile, the control method may further include acquiring a current temperature after operating the refrigerator in the second mode, and changing the second mode to the first mode to operating the refrigerator when the current temperature is lower than or equal to the critical temperature.

Meanwhile, the control method may further include acquiring the environmental noise related to the terminal device based on the audio information, acquiring the ratio of the refrigerator noise in the environmental noise, and acquiring the location information of the terminal device based on the refrigerator noise when the ratio is greater than or equal to the critical ratio.

Meanwhile, the control method of the refrigerator 100 as in FIG. 30 may be executed on the refrigerator 100 having the configuration of FIG. 2 or FIG. 3 and may also be executed on a device having other configurations.

Meanwhile, the methods according to various embodiments of the disclosure described above may be implemented in the form of an application that may be installed in the electronic device.

In addition, the methods according to the diverse embodiments of the disclosure described above may be implemented only by software upgrade or hardware upgrade for the existing electronic device.

Further, various embodiments of the disclosure described above may also be performed through an embedded server included in the electronic device or an external server of at least one of the electronic devices or the display apparatus.

Meanwhile, according to an embodiment of the disclosure, the diverse embodiments described above may be implemented as software including instructions stored in a machine-readable storage medium (e.g., a computer-readable storage medium). A machine may be an apparatus that invokes the stored instruction from the storage medium and may operate according to the invoked instruction, and may include the electronic device according to the disclosed embodiments. When the instruction is executed by a processor, the processor may perform the function corresponding to the instruction directly or by using other components under the control of the processor. The command may include codes created or executed by a compiler or an interpreter. The storage medium readable by the machine may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment of the disclosure, the methods according to the diverse embodiments described above may be included and provided in a computer program product. The computer program product may be traded as a product between a seller and a purchaser. The computer program product may be distributed in the form of a storage medium (e.g., a compact disc read only memory (CD-ROM)) that may be read by the machine or online through an application store (e.g., PlayStore™). In a case of the online distribution, at least portions of the computer program product may be at least temporarily stored in a storage medium such as memory of a manufacturer server, an application store server, or a relay server or be temporarily created.

In addition, each of components (e.g., modules or programs) according to the diverse embodiments described above may include a single entity or a plurality of entities, and some of the corresponding sub-components described above may be omitted or other sub-components may be further included in the diverse embodiments. Alternatively or additionally, some of the components (e.g., the modules or the programs) may be integrated into one entity, and may perform functions performed by the respective corresponding components before being integrated in the same or similar manner. Operations performed by the modules, the programs, or other components according to the diverse embodiments may be executed in a sequential manner, a parallel manner, an iterative manner, or a heuristic manner, at least some of the operations may be performed in a different order or be omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A refrigerator, comprising:
memory storing a preset frequency of the refrigerator and one or more computer programs;
a communication interface communicating with a terminal device;
a driving unit; and
one or more processors communicatively coupled to the memory,
wherein the one or more computer programs include computer-executable instructions that, when executed by the one or more processors individually or collectively, cause the refrigerator to:
receive audio information sensed by the terminal device from the terminal device through the communication interface while the refrigerator operates in a first mode,
extract refrigerator noise from the audio information based on the preset frequency,
acquire location information of the terminal device based on the refrigerator noise when the refrigerator noise is greater than or equal to a threshold value, and
control the driving unit to operate in a second mode different from the first mode when the terminal device is identified as being within a critical distance from the refrigerator based on the location information.

2. The refrigerator of claim 1, wherein the second mode is a low-noise mode that generates less noise than the noise generated in the first mode.

3. The refrigerator of claim 1,
wherein the memory stores a reference noise corresponding to the preset frequency and an error range corresponding to the preset frequency, and
wherein the one or more computer programs further include computer-executable instructions that, when executed by the one or more processors individually or collectively, cause the refrigerator to:
extract an audio signal corresponding to the preset frequency from among a plurality of noises included in the audio information, and
determine the extracted audio signal as the refrigerator noise when a size of the extracted audio signal is within the error range of the reference noise.

4. The refrigerator of claim 1, wherein the one or more computer programs further include computer-executable instructions that, when executed by the one or more processors individually or collectively, cause the refrigerator to extract the refrigerator noise from the audio information based on the preset frequency and a preset signal waveform.

5. The refrigerator of claim 1,
wherein the memory stores a distance estimation table indicating a distance corresponding to the refrigerator noise, and
wherein the one or more computer programs further include computer-executable instructions that, when executed by the one or more processors individually or collectively, cause the refrigerator to:
acquire the distance corresponding to the refrigerator noise as the location information of the terminal device based on the distance estimation table, and
control the driving unit to operate in the second mode when the distance is identified as being within the critical distance.

6. The refrigerator of claim 1,
wherein the one or more computer programs further include computer-executable instructions that, when executed by the one or more processors individually or collectively, cause the refrigerator to transmit a control signal requesting the audio information to the terminal device through the communication interface when a preset event occurs, and
wherein the preset event is an event identified as being connectable to the terminal device through the communication interface.

7. The refrigerator of claim 1, wherein the one or more computer programs further include computer-executable instructions that, when executed by the one or more processors individually or collectively, cause the refrigerator to:
identify whether the audio information includes a user conversation when the terminal device is within the critical distance from the refrigerator; and
control the driving unit to operate the refrigerator in the second mode when the audio information includes the user conversation.

8. The refrigerator of claim 7, wherein the one or more computer programs further include computer-executable instructions that, when executed by the one or more processors individually or collectively, cause the refrigerator to:
transmit a control signal requesting voiceprint information stored in the terminal device to the terminal device through the communication interface when the terminal device is within the critical distance from the refrigerator through the communication interface; and
identify whether the audio information includes the user conversation based on the voiceprint information when the voiceprint information is received from the terminal device through the communication interface.

9. The refrigerator of claim 1, wherein the one or more computer programs further include computer-executable instructions that, when executed by the one or more processors individually or collectively, cause the refrigerator to:
control the driving unit to operate the refrigerator in the second mode and then acquire a current temperature; and
operate the refrigerator by changing the second mode to the first mode when the current temperature is lower than or equal to a critical temperature.

10. The refrigerator of claim 1, wherein the one or more computer programs further include computer-executable instructions that, when executed by the one or more processors individually or collectively, cause the refrigerator to:
acquire environmental noise related to the terminal device based on the audio information;
acquire a ratio occupied by the refrigerator noise in the environmental noise; and
acquire the location information of the terminal device based on the refrigerator noise when the ratio is greater than or equal to a critical ratio.

11. A control method of a refrigerator storing a preset frequency of the refrigerator and communicating with a terminal device, the control method comprising:
receiving audio information sensed by the terminal device from the terminal device while the refrigerator operates in a first mode;
extracting refrigerator noise from the audio information based on the preset frequency;
acquiring location information of the terminal device based on the refrigerator noise when the refrigerator noise is greater than or equal to a threshold value; and
operating the refrigerator in a second mode different from the first mode when the terminal device is identified as being within a critical distance from the refrigerator based on the location information.

12. The control method of claim 11, wherein the second mode is a low-noise mode that generates less noise than the noise generated in the first mode.

13. The control method of claim 11,
wherein the refrigerator stores a reference noise corresponding to the preset frequency and an error range corresponding to the preset frequency, and
wherein, in the extracting of the refrigerator noise,
an audio signal corresponding to the preset frequency is extracted from among a plurality of noises included in the audio information, and
when a size of the extracted audio signal is within the error range of the reference noise, the extracted audio signal is determined as the refrigerator noise.

14. The control method of claim 11, wherein in the extracting of the refrigerator noise, the refrigerator noise is extracted from the audio information based on the preset frequency and a preset signal waveform.

15. The control method of claim 11,
wherein the refrigerator stores a distance estimation table indicating a distance corresponding to the refrigerator noise,
wherein, in the acquiring of the location information, the distance corresponding to the refrigerator noise is acquired as the location information of the terminal device based on the distance estimation table, and
wherein, in the operating of the refrigerator in the second mode, the refrigerator operates in the second mode when the distance is identified as being within the critical distance.

16. The control method of claim 11, further comprising:
transmitting a control signal requesting the audio information to the terminal device through a communication interface when a preset event occurs,
wherein the preset event is an event identified as being connectable to the terminal device through the communication interface.

17. The control method of claim 11, further comprising:
identifying whether the audio information includes a user conversation when the terminal device is within the critical distance from the refrigerator; and
controlling a driving unit to operate the refrigerator in the second mode when the audio information includes the user conversation.

18. The control method of claim 17, further comprising:
transmitting a control signal requesting voiceprint information stored in the terminal device to the terminal device through a communication interface when the terminal device is within the critical distance from the refrigerator through the communication interface; and
identifying whether the audio information includes the user conversation based on the voiceprint information when the voiceprint information is received from the terminal device through the communication interface.

19. One or more non-transitory computer-readable storage media storing one or more computer programs including computer-executable instructions that, when executed by one or more processors of a refrigerator individually or collectively, cause the refrigerator to perform operations, the operations comprising:
receiving audio information sensed by a terminal device from the terminal device while the refrigerator operates in a first mode;
extracting refrigerator noise from the audio information based on a preset frequency;
acquiring location information of the terminal device based on the refrigerator noise when the refrigerator noise is greater than or equal to a threshold value; and
operating the refrigerator in a second mode different from the first mode when the terminal device is identified as being within a critical distance from the refrigerator based on the location information.

20. The one or more non-transitory computer-readable storage media of claim 19, wherein the second mode is a low-noise mode that generates less noise than the noise generated in the first mode.
